(19) United States
(12) Patent Application Publication
(10) Pub. No.: US 2026/0252999 A1
(43) Pub. Date: Aug. 27, 2026

(54) SYSTEMS AND METHOD FOR DYNAMICALLY GENERATING DOCUMENTS USING A CONTEXT-AWARE COMPLIANCE ENGINE

(71) Applicant: WayThru Innovations LLC, Greenville, SC (US)

(72) Inventors: Thomas Marcial Kersting, Greenville, SC (US); Aaron Michael Brooks, Williamston, SC (US)

(21) Appl. No.: 19/365,782

(22) Filed: Oct. 22, 2025

Related U.S. Application Data
(60) Provisional application No. 63/761,406, filed on Feb. 21, 2025.

(51) Int. Cl. G06Q 10/0633; G06F 9/451; G06F 40/174; G06F 40/186; G06Q 30/018

(52) U.S. Cl. CPC G06Q 10/0633; G06F 9/451; G06F 40/174; G06F 40/186; G06Q 30/018

(57) ABSTRACT

This disclosure relates to a computer-implemented method for dynamic transaction document generation and execution. The method involves accessing a request for a transaction document from a first client computing device and determining a characteristic associated with that device. Based on this characteristic, a customized transaction document is generated. Instructions are sent to the first client computing device to display the agreement and an interactive element for a first user to execute it. Upon execution by the first user, second instructions are sent to one or more second client computing devices associated with a second user, displaying the agreement with the consumer's signature and providing an interactive element for the attorney's execution. After the attorney executes the agreement, a notification of the completed transaction document is generated and transmitted for display on one or more third client devices.

### PRIORITY

The present application claims the benefit of priority of U.S. Provisional Patent Application No. 63/761,406, filed on Feb. 21, 2025, which is incorporated by reference herein.

### FIELD

The present disclosure relates generally to improved computing systems and methods for implementing document workflows.

### BACKGROUND

Data processing techniques such as natural language processing services can include utilization and training of machine learned models for performing natural language processing. Data processing services can be developed depending on the information needed or outsourced, at cost, from companies offering such services. These services can be expensive and unreliable. Moreover, the effectiveness of any service can depend on the type of data being processed and the information needed from the processed data. For example, cheaper data processing techniques can be more effective than more expensive techniques for certain data. In this respect, there is no one size fits all and, as a result, one data processing service may not suitably serve the data processing needs of a significant number of users.

### SUMMARY

Aspects and advantages of embodiments of the present disclosure will be set forth in part in the following description, or may be learned from the description, or may be learning through practice of the embodiments.

One example aspect of the present disclosure is directed to a computer-implemented method for implementing a transaction document generation scheme. The method can include accessing data indicative of a request for transaction document generation from a first client device. The operations can include, based on accessing the data indicative of the request for transaction document generation, determining a first characteristic associated with the first client device. The operations can include, based on the first characteristic associated with the client device, generating a transaction document, wherein the transaction document includes at least a first portion selected based on the first characteristic. The method can include generating first instructions that are executable by one or more processors of the first client device to cause the first client device to automatically update a graphical user interface to display the transaction document and a first interactive user interface element. The method can include transmitting data including the first instructions to the first client device. The method can include accessing data indicative of first user input via the first interactive user interface element indicative of a first user executing the transaction document. The operations can include, based on accessing data indicative of the first user executing the transaction document, generating second instructions that are executable by one or more processors of one or more second client computing devices to cause the one or more second client computing devices to automatically update a graphical user interface to display the transaction document, a first signature associated with the first user executing the transaction document, and a second interactive user interface element. The method can include transmitting the second instructions to the one or more second client computing devices, wherein the one or more second client computing devices are associated with a second user. The method can include accessing data indicative of second user input via the second interactive user interface element indicative of the second user executing the transaction document. The method can include generating, based on accessing the data indicative of the second user input, third instructions that are executable by one or more processors of one or more third client devices to automatically update a graphical user interface of the one or more third client devices to provide for display a notification indicating completion of the transaction document.

Another example aspect of the present disclosure is directed to a computing system. The computing system includes one or more processors and one or more non-transitory computer-readable media that collectively store instructions that, when executed by the one or more processors, cause the computing system to perform operations. The operations can include accessing data indicative of a request for transaction document generation from a first client device. The operations can include, based on accessing the data indicative of the request for transaction document generation, determining a first characteristic associated with the first client device. The operations can include, based on the first characteristic associated with the client device, generating a transaction document, wherein the transaction document includes at least a first portion selected based on the first characteristic. The operations can include generating first instructions that are executable by one or more processors of the first client device to cause the first client device to automatically update a graphical user interface to display the transaction document and a first interactive user interface element. The operations can include transmitting data including the first instructions to the first client device. The operations can include accessing data indicative of first user input via the first interactive user interface element indicative of a first user executing the transaction document. The operations can include, based on accessing data indicative of the first user executing the transaction document, generating second instructions that are executable by one or more processors of one or more second client computing devices to cause the one or more second client computing devices to automatically update a graphical user interface to display the transaction document, a first signature associated with the first user executing the transaction document, and a second interactive user interface element. The operations can include transmitting the second instructions to the one or more second client computing devices, wherein the one or more second client computing devices are associated with a second user. The operations can include accessing data indicative of second user input via the second interactive user interface element indicative of the second user executing the transaction document. The operations can include generating, based on accessing the data indicative of the second user input, third instructions that are executable by one or more processors of one or more third client devices to automatically update a graphical user interface of the one or more third client devices to provide for display a notification indicating completion of the transaction document.

Yet another example aspect of the present disclosure is directed to one or more non-transitory computer-readable media including instructions that when executed by one or more computing devices cause the one or more computing devices to perform operations. The operations can include accessing data indicative of a request for transaction document generation from a first client device. The operations can include, based on accessing the data indicative of the request for transaction document generation, determining a first characteristic associated with the first client device. The operations can include, based on the first characteristic associated with the client device, generating a transaction document, wherein the transaction document includes at least a first portion selected based on the first characteristic. The operations can include generating first instructions that are executable by one or more processors of the first client device to cause the first client device to automatically update a graphical user interface to display the transaction document and a first interactive user interface element. The operations can include transmitting data including the first instructions to the first client device. The operations can include accessing data indicative of first user input via the first interactive user interface element indicative of a first user executing the transaction document. The operations can include, based on accessing data indicative of the first user executing the transaction document, generating second instructions that are executable by one or more processors of one or more second client computing devices to cause the one or more second client computing devices to automatically update a graphical user interface to display the transaction document, a first signature associated with the first user executing the transaction document, and a second interactive user interface element. The operations can include transmitting the second instructions to the one or more second client computing devices, wherein the one or more second client computing devices are associated with a second user. The operations can include accessing data indicative of second user input via the second interactive user interface element indicative of the second user executing the transaction document. The operations can include generating, based on accessing the data indicative of the second user input, third instructions that are executable by one or more processors of one or more third client devices to automatically update a graphical user interface of the one or more third client devices to provide for display a notification indicating completion of the transaction document.

Other example aspects of the present disclosure are directed to other systems, methods, apparatuses, tangible non-transitory computer-readable media, and devices for implementing a transaction document generation scheme.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

Detailed discussion of embodiments directed to one of ordinary skill in the art are set forth in the specification, which makes reference to the appended figures, in which:

FIG. 1 depicts a swim lane diagram for dynamically generating documents using a context-aware compliance engine according to example embodiments of the present disclosure;

FIG. 2 depicts a flowchart diagram of an example method for dynamically generating documents using a context-aware compliance engine according to example embodiments of the present disclosure;

FIG. 3A depicts example user interfaces for dynamically generating documents using a context-aware compliance engine according to example embodiments of the present disclosure;

FIG. 3B depicts example user interfaces for dynamically generating documents using a context-aware compliance engine according to example embodiments of the present disclosure;

FIG. 3C depicts example user interfaces for dynamically generating documents using a context-aware compliance engine according to example embodiments of the present disclosure;

FIG. 3D depicts example user interfaces for dynamically generating documents using a context-aware compliance engine according to example embodiments of the present disclosure;

FIG. 3E depicts example user interfaces for dynamically generating documents using a context-aware compliance engine according to example embodiments of the present disclosure;

FIG. 3F depicts example user interfaces for dynamically generating documents using a context-aware compliance engine according to example embodiments of the present disclosure;

FIG. 3E depicts example user interfaces for dynamically generating documents using a context-aware compliance engine according to example embodiments of the present disclosure;

FIG. 3G depicts example user interfaces for dynamically generating documents using a context-aware compliance engine according to example embodiments of the present disclosure;

FIG. 3H depicts example user interfaces for dynamically generating documents using a context-aware compliance engine according to example embodiments of the present disclosure;

FIG. 4 depicts a block diagram of an example computing system that performs a transaction document generation scheme according to example embodiments of the present disclosure;

FIG. 5 depicts a block diagram of an example computing system that performs a transaction document generation scheme according to example embodiments of the present disclosure;

FIG. 6 depicts a block diagram of an example computing system that performs a transaction document generation scheme according to example embodiments of the present disclosure.

### DETAILED DESCRIPTION

The disclosed technology relates generally to systems and methods for automated management of document workflows. For example, a computer-implemented method may include dynamically generating an agreement by modifying a template based on a set of rules retrieved from a compliance engine database. The rules may be selected based on one or more characteristics associated with a request. The system may also manage a sequential, multi-party electronic signing workflow, for instance, by routing the dynamically generated agreement between a first party and a second party. The system can be further configured to handle user feedback to enable the generation of an updated agreement for subsequent review and execution.

The present disclosure relates generally to computer systems for managing digital document workflows, and more specifically, to systems for generating and executing multi-party agreements.

In some computing environments that handle transactional documents, one technical challenge may be the generation of agreements that are subject to a complex and varied set of rules. For example, one type of agreement may have different requirements based on geographic jurisdiction, client-specific policies, or account-specific details. Some approaches to this problem may involve maintaining a library of static document templates, where a separate template is stored for each combination of variables. Managing a number of templates may be computationally inefficient in terms of storage and processing, and the process may be susceptible to human error. When a legal or client requirement changes, a system administrator may need to manually identify and update numerous templates, a process that may risk introducing inconsistencies and errors, potentially affecting data integrity and leading to inefficient use of computational cycles. Furthermore, some systems may have difficulty managing the integrity of a multi-user workflow in a distributed computing environment. In a workflow involving sequential actions by different parties, some existing systems may lack certain technical mechanisms to control the sequence of operations and manage the state of the shared digital asset. This may lead to processing delays and can create a risk of data corruption or race conditions, particularly when a task can be handled by any member of a pool of users. Moreover, some systems may be static and non-adaptive. When a user rejects a document, the system may only register the rejection event without capturing a structured reason for the rejection. This lack of a feedback mechanism may prevent the computing system from correcting data errors, which can cause the same invalid document to be repeatedly regenerated and require manual, out-of-band intervention to diagnose and address the root cause.

Therefore, a need exists for an improved computing system that can more efficiently generate compliant documents and manage a sequential multi-user workflow.

Certain conventional methods for creating and executing legal agreements can be manual and time-consuming. Such processes may rely on staff to manually draft documents, populate them with data, and transmit them via disparate systems. This approach can introduce time delays and may increase the likelihood of clerical errors. In some cases, these factors can result in agreements not being successfully executed. The disclosed technology provides a technical approach to these issues by describing an automated digital process that can replace or supplement certain manual workflows.

An example implementation includes a system configured for dynamic, rules-based document compilation using a compliance engine. Rather than maintaining a large library of static document templates for many combinations of jurisdiction, client, and account type, the system can utilize a database of discrete compliance rules. These rules can include, for example, legal requirements for various jurisdictions or client-specific disclosure preferences. When an agreement is requested, the system can identify a relevant context, query the database to retrieve a specific set of rules applicable to that context, and programmatically assemble a customized document. This type of dynamic document generation may contribute to accuracy, scalability, and ease of maintenance as compared to systems that rely on large sets of static templates.

In various embodiments, a system can provide a multi-step workflow. For instance, a process may begin when the system receives a request for an agreement from a first client device (e.g., a personal computer, smartphone, or tablet) associated with a first user. Based on characteristics of the request, such as the user's jurisdiction, the system can generate an agreement using a compliance engine. The system may then transmit instructions to the first client device to display the agreement and an interface for electronic signature. Upon receiving an indication of execution from the first user, the system can route the signed agreement to one or more second client computing devices associated with a second user for review and counter-signature. After the agreement is executed by the involved parties, the system may generate a notification of completion and can transmit the final document to a system of record. Such an integrated, sequential workflow may offer technical advantages by improving the likelihood of compliance and reducing the time required to secure a binding agreement.

In various embodiments, the disclosed technology relates to a computer-implemented method and system for the automated, rules-based generation and sequential, multi-party execution of legal documents, such as transaction documents. A system may be implemented as a cloud-based, software-as-a-service (SaaS) application operating on one or more server computers communicatively coupled to a plurality of client devices over a network, such as the Internet. The system architecture may be based on a microservices model, wherein distinct functions such as document generation, compliance verification, user authentication, and notification management may be handled by independent, scalable services. This distributed architecture may provide for high availability, fault isolation, and the ability to process a high volume of concurrent document workflows. The system may be configured to interact with different classes of users, including, for example, first users, second users, and creditor or client administrator users, each interacting with the system via respective client devices. A client device may be, for example, a desktop computer, a laptop computer, a tablet, a smartphone, a wearable computing device, or another processor-based device.

A process may be initiated when the system accesses data indicative of a request for a transaction document, the request originating from a first client device associated with a first user. This request may not be an explicit “generate agreement” command, but may be inferred from the consumer's actions within a graphical user interface provided by the system. For instance, a first user may first authenticate a user session by providing credentials to a web-based portal. Within this portal, the consumer may be presented with one or more repayment plan options for an outstanding debt. The consumer's selection of a specific plan and confirmation of its terms, such as by activating a “Continue” or “Confirm Plan” button, may cause the first client device to transmit data that the system may interpret as a request for transaction document generation. In response to accessing this data, the system may be configured to determine one or more characteristics associated with the request, the first user, or the first client device. These characteristics can serve as inputs for the dynamic generation of the agreement. Such characteristics can include, for example, the geographic jurisdiction of the first user, which may be determined from an address stored in an account profile, from IP geolocation of the first client device, or from user input. Other characteristics may include an identifier for a client entity (e.g., a law firm or creditor), a specific type of debt account (e.g., a credit card account or auto loan account), or other attributes associated with the consumer's account.

Based on the determined characteristics, the system may proceed to generate a unique, compliant transaction document. In some embodiments, the system may operate without relying on a large library of static, pre-written templates. Instead, the system may utilize a specialized compliance engine that queries a structured compliance engine database. This database may store a plurality of discrete compliance rules, where each rule may be a specific legal clause, a disclosure statement, a formatting instruction, or a client-specific business rule. Each rule in the database may be associated with one or more contexts, such as a particular state, a federal regulation, a specific client identifier, or an account type. Upon receiving the request, the system's one or more processors may query the compliance engine database to identify and retrieve a subset of the plurality of compliance rules that directly correspond to the determined characteristics of the request. For example, for a consumer in a particular state associated with a specific client, the system may retrieve all rules tagged for that state and for that client's identifier. The system may then generate the stipulation agreement by programmatically modifying a base template document based on the identified subset of rules. This modification process may involve inserting retrieved legal clauses into designated sections of the template, populating disclosure fields, and applying specific formatting. Simultaneously, the system may query a separate client database, for example via an application programming interface (API), to retrieve account-specific data such as the consumer's name, address, account number, a total payoff amount, an agreed-upon monthly payment amount, and a time to pay off, and may populate corresponding variable fields within the template. The result can be a dynamically assembled stipulation agreement that is tailored to the specific legal and business context of the transaction.

After the transaction document is generated, the system may create first instructions that are executable by one or more processors of the first client device. These instructions, when executed by a web browser or a dedicated application on the first client device, may cause the device to automatically update its graphical user interface to display the generated transaction document. The agreement may be presented within an embedded document viewer. The graphical user interface may also include a first interactive user interface element, which can provide the first user with controls to act upon the document. For instance, the element may include distinct buttons or selectable options for executing the agreement, rejecting the agreement, or saving the agreement for later review. The system may then transmit data including these first instructions to the first client device. The system may be configured to await and access data from the first client device indicative of the first user's input. In one path, the user may provide input via the first interactive user interface element that is indicative of the first user executing the transaction document, for example, by clicking a “Sign” or “Agree” button. This action may invoke an integrated electronic signature service to cryptographically apply the first user's signature to the document data.

In an alternative workflow path, the system may be configured to manage user rejections and facilitate in-workflow corrections. If the first user provides input via the first interactive user interface element indicative of rejecting the transaction document, the system may be configured to also access data indicating a reason for the rejection. The graphical user interface may present a further interactive element, such as a drop-down menu of predefined reasons or a text box for a custom explanation, to capture this information from the user. Upon accessing data indicative of the rejection and the associated reason, the system may programmatically update a status data structure, changing a status associated with the transaction document from a pending state to a “rejected by first user” status. The system may then use the captured reason as a programmatic input to attempt an automatic correction. For example, if the reason indicates an incorrect name or address, the system may be configured to automatically generate an updated transaction document by re-querying source databases for the correct data and re-running the document generation process. The system may then generate and transmit second instructions to the first client device to display this updated transaction document and an updated interactive user interface element, allowing the consumer to review and execute the corrected document within the same user session. This closed-loop feedback mechanism can allow the system to be self-correcting, which may improve data integrity and workflow efficiency.

Upon accessing data indicative of the first user successfully executing the transaction document, either an original or an updated version, a workflow management component of the system may transition the agreement to a next stage. The system may generate second instructions that are executable by one or more processors of one or more second client computing devices. These second client computing devices may be associated with one or more second users who are authorized to countersign the agreement on behalf of a creditor or law firm. One aspect of the system may include an ability to manage a pool of second users. In some implementations the pool of second users can include a pool of attorney users. The one or more second client computing devices may be associated with a legal entity including a plurality of second users. Instead of routing a task to a single, specific attorney, the system may place the pending agreement in a shared queue accessible by authorized attorneys in the pool. This design may mitigate delays caused by an individual's unavailability. The second instructions may cause the one or more second client computing devices to automatically update a graphical user interface to display the transaction document, which may now include a first signature or other indication of the first user's execution. The interface may also include a second interactive user interface element for the second user's action.

An authorized second user, operating a second client computing device (e.g., a mobile phone or a desktop computer), can access the queue, select an agreement to review, and interact with the second interactive user interface element. This element may provide options for the second user to execute the agreement, decline it (potentially with a reason), or relinquish the task back to the shared queue for another attorney to handle. The system may be configured to access data indicative of the second user input from the second user's device. If the input indicates that the second user is executing the transaction document, the system may apply the attorney's signature, thereby creating a fully executed document. Following the successful execution by the second user, the system may generate third instructions to provide a notification of completion. These instructions can be transmitted to various third client devices, which may include the consumer's first client device, the attorney's second client computing device, and a device associated with a creditor entity. This notification may confirm that the agreement is fully executed. Furthermore, the system may automatically transmit the final, executed document in a portable format, such as a PDF, to a client's designated system of record for archival and future use. An example future use could be initiating a wage garnishment if the consumer later defaults on the agreed-upon payment plan.

In some contemplated embodiments, the system may further include a machine-learned model to provide decision support regarding a potential resolution path for a given debt account. Over time, the system may collect a volume of data regarding stipulation offers, success rates, rejection reasons, and subsequent payment performance. This data can be used to train a machine-learned model. The system may process input including data associated with a client identifier or account, such as account age, debt principal, debt type, a consumer credit score, a consumer payment history, historical stipulation success rates for similar accounts, and estimated litigation costs for the relevant jurisdiction. The machine-learned model may process this input to generate an output that includes a recommendation, such as a “proceed with stipulation” or “proceed with litigation” classification, along with a confidence score for that recommendation. In some implementations, the output may further include quantitative predictions, such as an estimated net recovery amount for pursuing a stipulation versus an estimated net recovery for pursuing litigation, which may allow a creditor to make a more data-driven economic decision. This predictive capability may provide forward-looking strategic guidance that may not be available in some other systems.

Example aspects of the present disclosure are directed to improved systems and methods for generating transaction documents, identifying errors, and updating the generation scheme to more efficiently and accurately generate transaction documents aligning with a number of disparate documents such as statutes, policies, user agreements, and the like. Generally, this disclosure relates to a system and method for automating the creation, review, and execution of transaction documents within the legal collections industry. The system can utilize AI-driven machine learning to generate customized repayment plans, incorporating client-specific data and legal compliance requirements. The present disclosure can provide for automatically updating documents based on rejection reasons to allow for improved transaction document generation. A user-friendly interface can allow consumers to select plans, input payment details, and electronically sign agreements, which can then be routed for attorney review via a secure, integrated workflow. The entire process can be monitored in real-time, providing immediate feedback and enabling rapid resolution of discrepancies.

In a first working example, a computing system implementing the disclosed technology can be configured to automate a multi-party transaction document workflow for a debt collection law firm. For instance, the transaction document can be a stipulation agreement. The system can be deployed as a cloud-based service on one or more server computers. A first user, utilizing a first client device (e.g., a personal computer, smartphone, or tablet) running a web browser, may log into a secure online portal provided by the system. The consumer can be presented with several repayment plan options for an outstanding account. The consumer may select a plan with a specified monthly payment amount and term and confirm the selection. This action can cause the first client device to transmit data to the server computers, which the system can access as a request for stipulation agreement generation. The system can determine a characteristic associated with the request, for instance, that the consumer's jurisdiction is “State A,” based on account information stored in a client database.

Based on the “State A” jurisdiction, the system's one or more processors can execute instructions to query a compliance engine database to retrieve a subset of compliance rules associated with State A state law, which may include a specific disclosure clause. The system can then programmatically generate a stipulation agreement by inserting this Texas-specific clause into a base template document and populating variable fields with the consumer's account data and the selected payment plan terms. The system can generate and transmit instructions to the first client device, which can cause the device to display the populated, compliant agreement and a first interactive user interface element for electronic signature. The consumer may review the document and provide user input via the interface element to execute the agreement.

Upon accessing data indicative of the consumer's execution, the system can update a status data structure for the agreement to a status such as “Pending Attorney Signature.” The system can then generate and transmit second instructions to a pool of second client computing devices associated with authorized second users at the law firm. A second user, utilizing a second client computing device (e.g., a smartphone), may receive a notification, such as an email. The attorney can open a link from the notification, authenticate their identity, and be presented with a graphical user interface displaying the consumer-signed agreement and a second interactive user interface element for counter-signature. The attorney can review the document and provide input to execute the agreement. Upon accessing data indicative of the attorney's execution, the system can generate and transmit third instructions to the consumer's first client device and to a third client device associated with the law firm's administrator, providing a notification that the stipulation agreement is complete. The system can also generate a portable format (e.g., PDF) of the fully executed agreement and transmit it via an API to be filed in the law firm's system of record. This automated workflow may reduce the time to achieve a fully executed agreement from a period of several days or weeks to a much shorter duration, for example, approximately 90 seconds. The workflow may also reduce the fall-out rate of uncompleted agreements, for instance, from over 20% to less than 1%.

In a second working example, the system can be configured to manage a workflow involving a user rejection and automated correction. A first user can be presented with a generated stipulation agreement on their client device, as described in the first example. Upon reviewing the document, the consumer may notice their last name is misspelled. The user can provide input via the first interactive user interface element to reject the agreement. The graphical user interface can then update to display a second interactive element prompting the user for a reason for the rejection. The consumer can select “Incorrect Account Information” from a dropdown list and type “Last name is spelled ‘Smith’, not ‘Smyth’” into an associated text field. The system can access this data, including the structured reason for rejection.

Based on accessing this data, the system's processors can execute instructions to update a status data structure associated with the agreement to a status such as “Rejected by Consumer.” The system can then use the structured reason as a programmatic input. For instance, the system can execute a data validation routine that compares the name in the generated document against the name stored in the client's primary system of record, which can be accessed via an API. The routine may confirm the discrepancy. The system can then generate an updated stipulation agreement by re-running the document generation process using the verified correct name (“Smith”) from the system of record. The system can generate and transmit new instructions to the consumer's client device, which can cause the device to update the graphical user interface to display the corrected, updated stipulation agreement and a new interactive element for execution. The consumer can then review the corrected document and execute it. This type of closed-loop feedback mechanism allows the system to be self-correcting. The system can use structured user input to resolve a data integrity issue in real time within a single user session, which may reduce the likelihood of workflow failure and can reduce the need for out-of-band manual intervention

In a third working example, the system can include a machine-learned model to provide decision support to a creditor client. The system can collect and store a large dataset of historical transactions, including account attributes, stipulation terms offered, success and failure rates of stipulation execution, and subsequent consumer payment performance. This data can be used to train a machine-learned model, such as machine-learned classification model. A client administrator user, operating a client device, may consider whether to offer a stipulation agreement to a consumer associated with a new high-balance account. The system can be configured to process input data associated with this specific account. The input data can include a vector of features, such as: (i) an account age of 180 days, (ii) a debt principal of $15,000, (iii) a debt type of “unsecured personal loan,” (iv) the consumer's credit score, (v) a consumer payment history showing some prior payments, (vi) an estimated litigation cost of $2,500.

The one or more processors can execute instructions to process this input vector through the trained machine-learned model. The model can generate an output including a recommendation and associated quantitative estimates. For example, the output can be: (i) a recommendation of “Proceed with stipulation agreement” and a confidence score of “90%” for the recommendation. In some cases, the output can further include: (i) an estimated net recovery for pursuing the stipulation and (ii) an estimated net recovery for pursuing litigation. The system can then generate and transmit instructions to the client administrator's device to display this output, for instance, in a dashboard. This capability can provide a technical effect of transforming historical data into forward-looking guidance. This may enable a client to make a more data-driven decision than may be possible with some conventional systems.

The present disclosure can provide a number of technical effects and benefits. For example, the present disclosure provides for a real-time feedback loop to enable continuous improvement in system performance and efficiency by capturing rejections, categorizing them, and analyzing rejections to generate a new approach for stipulation agreement generation. As such, the model can be continuously trained to capture more accurate rejection issues, which can result in a system that provides more effective and accurate agreement generation. The present disclosure can provide for improvements in computing technology by improving the machine learned model used for generating stipulation agreements. By improving the machine learned model, the computing technology can improve in terms of processing efficiency by reducing latency and improving the speed with which machine learned models can be used. Additionally, use of computer resources can be improved via reducing the number of calls to external systems or using less bandwidth to communicate with external systems. As such, the disclosure can provide significant improvements and advantages over prior systems.

An additional technical advantage of this system lies in its real-time feedback loop. Unlike existing approaches that rely on post-hoc analysis of agreement rejections, this system captures rejection reasons (from both consumers and attorneys) immediately. This allows for instantaneous identification of issues, such as stipulations violating rules or requirements, enabling immediate corrective action and preventing delays. The system's AI engine can analyze this real-time data to dynamically refine workflows and system parameters, continuously improving efficiency and compliance. This proactive approach minimizes errors and maximizes approval rates, resulting in significant cost savings and faster resolution times compared to traditional methods.

The system's architecture can be built upon a microservices model with real-time data processing to ensure high scalability and fault isolation. The multi-tenant environment allows for secure and compliant operation across multiple clients. In some implementations, the present disclosure can integrate with microservices for obtaining signatures or otherwise executing the documents. As such, functionalities from existing tools can be utilized to streamline computing resources to focus on generation of stipulation agreements and improving the underlying model responsible for generating such agreements. Thus, the AI-powered optimization reports can provide actionable insights for continuous improvement. This combination of features can lead to a more efficient, cost-effective, and consumer-centric debt resolution process, significantly outperforming existing manual or less-integrated systems.

An example technical problem solved by example implementations of aspects of the present disclosure may include the inefficient and error-prone generation of legally compliant documents in a computing environment. Some systems may rely on maintaining a large library of static document templates, where a separate template is stored for each combination of jurisdiction, client, and account type. Managing and updating this large number of templates can be computationally expensive in terms of storage and processing resources, and it can be susceptible to human error, which may lead to the generation of legally invalid documents. When a legal or client requirement changes, a system administrator may need to manually identify and update numerous templates, a process that can risk introducing inconsistencies and errors. This lack of a dynamic data processing workflow for document construction may result in poor data integrity and wasted computational cycles.

Example implementations of aspects of the present disclosure may provide technical solutions to this problem by implementing a computing system including a compliance engine. For example, a system can include a compliance engine database storing a plurality of discrete compliance rules, where each rule may be associated with a specific context, such as a jurisdiction or a client identifier. When the system receives a request for a stipulation agreement, its one or more processors can be configured to query this structured database to identify a specific subset of rules corresponding to the context of the request. Instead of selecting from a large set of complete templates, the system can generate the stipulation agreement by programmatically modifying a base template document according to the identified subset of rules. This process can be further enhanced by querying a separate database for client-specific data, such as account details, and automatically populating the corresponding fields in the template. This technical arrangement may provide the technical effect of a more efficient and scalable document generation process. It can change the data architecture from a system of static templates to a relational database of rules, thereby reducing storage requirements and processing overhead. This may improve the data integrity of the generated document by allowing it to be dynamically and consistently assembled from verified, context-specific rule components, which can represent a technical improvement in the functioning of the computer system.

Another example technical problem solved by example implementations of aspects of the present disclosure may include the management of data consistency and workflow integrity in a distributed, multi-user computing system. In a workflow involving sequential actions by different parties (e.g., a consumer and an attorney), some systems may lack a robust technical mechanism to control the sequence of operations and manage the state of the shared digital asset, such as a stipulation agreement. This can lead to processing delays and can create a risk of data corruption or race conditions, particularly when a task can be handled by any member of a pool of users (e.g., multiple attorneys). Without a centralized and automated state management system, different parts of the distributed system may hold inconsistent information about the status of the agreement, leading to process failures and a lack of a reliable audit trail for the transaction.

Example implementations of aspects of the present disclosure may provide technical solutions to this problem by implementing an automated, event-driven workflow manager, e.g., by workflow management component. A computer-implemented method can control the flow of data and instructions between different client devices in an ordered sequence. For instance, the system may generate and transmit instructions to one or more attorney client devices only after, and specifically based on, accessing data indicating that the first user has executed the stipulation agreement. This event-driven trigger mechanism can contribute to the workflow proceeding in the correct order without manual intervention. The system can further manage workflow state by updating a status data structure upon the completion of each step, such as changing a status from “pending consumer” to “pending attorney.” This can provide a single, consistent source of information for the document's state across the distributed system. This technical implementation may provide the technical effect of improved reliability and efficiency for the distributed computing system by creating a control mechanism that can improve data consistency and reduce the likelihood of race conditions. By automating the routing of data and tasks based on a centrally managed state, the system may reduce latency and improve the integrity of the multi-user transaction process.

Another example technical problem solved by example implementations of aspects of the present disclosure may include the static and non-adaptive nature of some document exchange systems. When a user in such a system rejects a document, the system may only register the rejection event, and the reason for the rejection might not be captured or could be communicated through unstructured, out-of-band channels. This lack of an integrated, real-time feedback mechanism can prevent the computing system from automatically correcting errors. As a result, the same underlying data or process error can cause subsequent document generation attempts to fail repeatedly, wasting computational resources in regenerating the same invalid document and requiring manual intervention to diagnose and fix the root cause. The system may thus be unable to dynamically improve its own data processing accuracy.

Example implementations of aspects of the present disclosure may provide technical solutions to this problem by implementing a real-time, closed-loop feedback and correction system. The system can be configured not only to process a user's acceptance of an agreement but also to access data indicative of a user rejecting the agreement along with a structured reason for the rejection. This captured reason data can then be used as a direct, programmatic input for a subsequent automated action: generating an updated stipulation agreement that is based on the provided reason. For example, if the reason indicates an incorrect data point, the system can automatically re-query its data sources and regenerate the document with corrected information within the same user session. This may provide the technical effect of a self-correcting data processing system that can improve data integrity and reduce process latency. By creating an automated feedback loop, the system can dynamically resolve errors without terminating the workflow, thereby increasing the efficiency of the computer and the likelihood of a successful transaction. This allows the system to operate as a dynamic data processing engine that can use structured user feedback as a control input to improve its own operational accuracy in real time.

Reference now will be made in detail to embodiments, one or more examples of which are illustrated in the drawings. Each example is provided by way of explanation of the embodiments, not limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

Various example implementations are described herein with respect to the accompanying Figures.

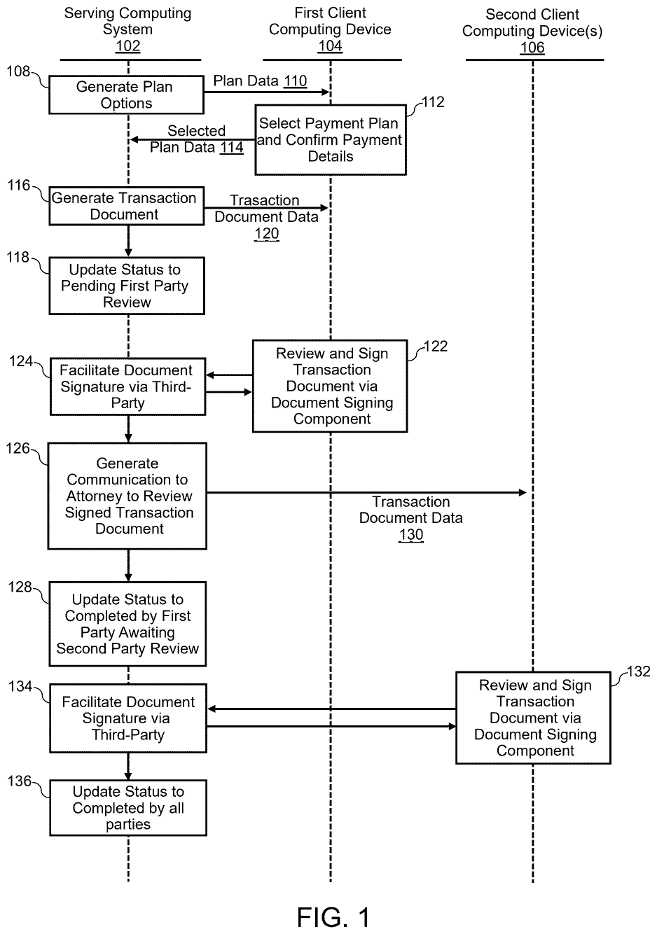

FIG. 1 depicts an example swim lane diagram illustrating an implementation of a system and process for generating and executing a stipulation agreement. The implementation can involve a server computing system 102, a first client computing device 104, and one or more second client computing device(s) 106. The server computing system 102 can execute a process to generate plan options 108, which produces plan data 110 transmitted to the first client computing device 104. The first client computing device 104 can execute a process to select payment plan and confirm payment details 112, which produces selected plan data 114 transmitted to the server computing system 102. In response, the server computing system 102 can generate transaction document 116, producing transaction document data 120 that can be sent for a first party signature. This can involve an update status to pending first party review 118, a process to review and sign transaction document via document signing component 122 on the first client computing device 104, and a process to facilitate document signature via third-party 124 on the server computing system 102. Following the completion of the first signature, the server computing system 102 can generate communication to attorney to review signed transaction document 126 and update status to completed by first party awaiting second party review 128. Transaction document data 130 can then be sent for a second party signature, involving a process to review and sign transaction document via document signing component 132 on the second client computing device(s) 106 and a process to facilitate document signature via third-party 134 on the server computing system 102. Upon completion, the server computing system 102 can update status to completed by all parties 136.

The system can include a server computing system 102, a first client computing device 104, and one or more second client computing device(s) 106. The server computing system 102 can be one or more computing devices, such as application servers, web servers, or database servers, configured to execute the described processes. The first client computing device 104 can be a computing device operated by a first party, for example, a personal computer, smartphone, or tablet. The second client computing device(s) 106 can be one or more computing devices operated by a second party or parties, for example, an attorney's desktop computer or mobile device. Communication between the server computing system 102, the first client computing device 104, and the second client computing device(s) 106 can occur over one or more networks.

The server computing system 102 can execute a process to generate plan options 108. This process can involve one or more processors executing instructions to create one or more potential payment plans based on account data. The output of this process can be plan data 110. The plan data 110 can be a data structure containing information about the available plans, such as payment amounts, frequencies, and durations. The plan data 110 can be transmitted from the server computing system 102 to the first client computing device 104.

The first client computing device 104 can execute a process to select payment plan and confirm payment details 112. This process may involve presenting the plan data 110 to a user via a graphical user interface and receiving user input indicating a selection of one of the plans. The output of this selection can be selected plan data 114. The selected plan data 114 can be a data structure representing the specific plan chosen by the user. The selected plan data 114 can be transmitted from the first client computing device 104 to the server computing system 102.

The server computing system 102 can execute a process to generate transaction document 116. This process can use the received selected plan data 114 as an input to dynamically assemble a legal agreement document. The output can be transaction document data 120. The transaction document data 120 can be a data structure representing the generated agreement, for example, a document in a format such as PDF or HTML. Concurrently, the server computing system 102 may perform a process to update status to pending first party review 118, which can involve modifying a record in a database to reflect the current state of the workflow. The transaction document data 120 can be transmitted from the server computing system 102 to the first client computing device 104.

The first client computing device 104 can execute a process to review and sign transaction document via document signing component 122. This process may involve displaying the transaction document data 120 and providing an interface for a user to electronically sign the document. This process can be managed by a server-side process to facilitate document signature via third-party 124. The process to facilitate document signature via third-party 124 can involve the server computing system 102 communicating with an external electronic signature service to manage the signing ceremony. An external electronic signature service can provide a document signing component or document execution service.

After the first party signature is captured, the server computing system 102 can execute a process to generate communication to attorney to review signed transaction document 126. This can involve creating and sending a notification, such as an email or an application alert. The server computing system 102 can also execute a process to update status to completed by first party awaiting second party review 128, which can modify a status record in a database. The server computing system 102 can then transmit transaction document data 130 to the second client computing device(s) 106. The transaction document data 130 can represent the same agreement as the transaction document data 120 but may now also include data representing the first party's signature. In some cases a first party can include a first user.

The second client computing device(s) 106 can execute a process to review and sign transaction document via document signing component 132. This process may be similar to the first party's signing process, involving the display of the transaction document data 130 and an interface for a second party to provide a countersignature. In some cases, a second party can include a second user. This can be managed by a server-side process to facilitate document signature via third-party 134, which can again involve the server computing system 102 communicating with an electronic signature service.

Upon completion of all signatures, the server computing system 102 can execute a final process to update status to completed by all parties 136. This process can involve updating a database record to indicate that the agreement is fully executed, which may conclude the workflow.

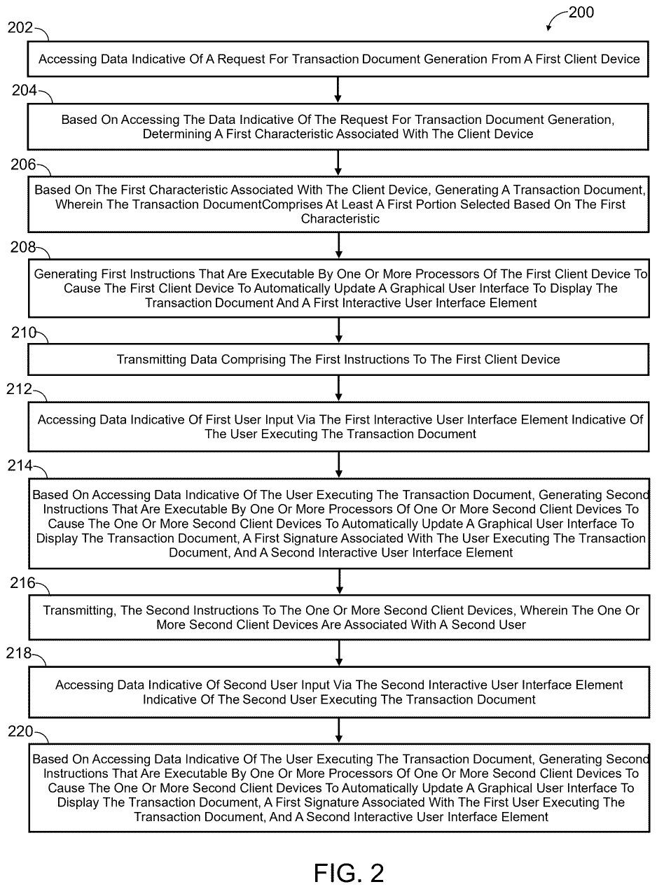

FIG. 2 depicts a flowchart of a method 200 for dynamic transaction document generation and execution in accordance with one or more example embodiments of the present disclosure. The method 200 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, method 200 is performed by a server computing system (e.g., server computing system 630) or client computing system (e.g., client computing device 602). Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processors can be omitted in various embodiments. Thus, not all processes are required in every embodiment. Other process flows are possible.

At operation 202, processing logic can access data indicative of a request for transaction document generation from a first client computing device. For instance, a server computing system receiving a signal or message from a client device, such as a personal computer or a smartphone. The request may be generated, for example, in response to a user selecting a repayment plan within a web portal. In some implementations, a transaction document can include a stipulation agreement.

At operation 204, processing logic can determine, based on accessing the data indicative of the request for transaction document generation, a first characteristic associated with the client device. For instance, processing logic can analyze data associated with the request or an associated user account. The first characteristic can be, for example, a geographic jurisdiction determined from an IP address, or a client identifier retrieved from account data.

At operation 206, processing logic can generate, based on the first characteristic associated with the client device, a transaction document. The transaction document can include at least a first portion selected based on the first characteristic. This generation can include processing logic modifying a base template document by inserting or altering content, such as legal disclosures or clauses, based on the determined first characteristic. The transaction document comprises at least a total payoff amount, a monthly payment amount, and a time to payoff. The first characteristic comprises at least one of: (i) a jurisdiction of a user associated with the first client computing device, (ii) an identity of the first user, or (iii) an account type.

Generating the transaction document can include processing logic accessing a compliance engine database including at least one of: (i) legal requirements or (ii) client-specific disclosure preferences. The legal requirements can include at least one of (i) federal legal requirements, (ii) state legal requirements, or (iii) local legal requirements. The first characteristic comprises a location of the first client computing device, and wherein the first portion comprises a portion associated with a state legal requirement.

At operation 208, processing logic can generate first instructions that are executable by one or more processors of the first client computing device to cause the first client computing device to automatically update a graphical user interface to display the transaction document and a first interactive user interface element. The first instructions can be, for example, code such as HTML, CSS, or JavaScript. The first interactive user interface element may be a graphical control, such as a button or checkbox, for indicating execution of the agreement. In some instances, the first interactive user interface element can include an interactive component for obtaining a signature. A third-party signature service can be utilized to authenticate the signature based on login credentials or some other means of identity verification.

In some implementations, processing logic can authenticate a first user session associated with the first client computing device. Based on authenticating the first user session, processing logic can generate the first instructions.

At operation 210, processing logic can transmit data including the first instructions to the first client computing device. This transmission can occur over a network connection.

At operation 212, processing logic can access data indicative of first user input via the first interactive user interface element indicative of the user executing the transaction document. This can involve the server computing system receiving a confirmation message from the first client computing device after a user interacts with the first interactive user interface element.

In some instances, upon receipt of the data indicative of the user executing the transaction document, processing logic can update a centralized data structure indicating a status associated with the transaction document. For instance, the status can include “signed by the first user.” The centralized data structure can provide for data consistency across distributed systems. This can reduce process failures and enhance reliability of the computing system as a whole.

At operation 214, processing logic can generate, based on accessing data indicative of the user executing the transaction document, second instructions that are executable by one or more processors of one or more second client computing devices to cause the one or more second client computing devices to automatically update a graphical user interface to display the transaction document, a first signature associated with the user executing the transaction document, and a second interactive user interface element. The second instructions can be configured to present the now partially-signed agreement to a different user on a different device. The second interactive user interface element may be a control for providing a countersignature. For instance, the first signature can be associated with a consumer and the second signature can be associated with an attorney.

At operation 216, processing logic can transmit the second instructions to the one or more second client computing devices. The one or more second client computing devices are associated with a legal entity comprising a plurality of second users including the second user. In some implementations the plurality of second users can include a plurality of attorney users. In some implementations, the second user can include an attorney user. The one or more second client computing devices can be associated with a second user. The one or more second client computing devices can be, for example, computers or mobile devices used by legal personnel.

At operation 218, processing logic can access data indicative of second user input via the second interactive user interface element indicative of the second user executing the transaction document. This may involve the server system receiving a confirmation message from one of the one or more second client computing devices.

In some instances, upon receipt of the data indicative of the second user executing the transaction document, processing logic can update a centralized data structure indicating a status associated with the transaction document. For instance, the status can include “signed by the second user” or “completed by all parties.” The centralized data structure can provide for data consistency across distributed systems. This can reduce process failures and enhance reliability of the computing system as a whole.

At operation 220, processing logic can generate, based on accessing the data indicative of the second user input, third instructions that are executable by one or more processors of one or more third client devices to automatically update a graphical user interface of the one or more third client devices to provide for display a notification indicating completion of the transaction document. The third instructions can be configured to cause a notification to be displayed. The one or more third client devices may include the first client computing device, the one or more second client computing devices, or a separate client device or system, such as a system belonging to a creditor entity. The notification can be, for example, a message displayed in a user portal, an email, or a text message.

In some instances, instead of accepting an agreement, a consumer or second user may reject the proposed agreement. As such, processing logic can perform additional or alternative operations. For instance, processing logic can access data indicative of first user input via the first interactive user interface element indicative of a first user rejecting the transaction document and a reason for the first user rejecting the transaction document.

Processing logic can update, based on accessing the data indicative of the first user rejecting the transaction document, a status data structure to update a status associated with the transaction document to be a rejected by first user status. For instance, the centralized data structure associated with status can be updated to include a rejected by first user status.

Processing logic can generate an updated transaction document based on the reason for the first user rejecting the transaction document. For instance, processing logic can process structured data indicative of a reason for rejection. Based on the reason for rejection, processing logic can automatically trigger a corrective action. For instance, a corrective action can include querying data sources, such as a compliance engine database or user database to regenerate the transaction document. As such, processing logic can perform self-correcting data processing engine which can improve its own operational accuracy and data integrity in real-time, or near real-time. This can reduce latency and need for manual intervention.

Processing logic can generate second instructions that are executable by the one or more processors of the first client computing device to cause the first client computing device to automatically update the graphical user interface to display the updated transaction document and an updated interactive user interface element.

Processing logic can access data indicative of second user input via the updated interactive user interface element indicative of the first user executing the transaction document.

Processing logic can modify, based on accessing data indicative of the first user executing the transaction document, the status data structure to update the status associated with the transaction document to be an accepted by the first user status.

Processing logic can generate, based on accessing data indicative of the first user executing the transaction document, third instructions that are executable by one or more processors of one or more second client computing devices to cause the one or more second client computing devices to automatically update the graphical user interface to display the transaction document, a first signature associated with the first user executing the transaction document, and a second interactive user interface element.

Processing logic can transmit the third instructions to the one or more second client computing devices. The one or more second client computing devices are associated with a second user.

Processing logic can access data indicative of second user input via the second interactive user interface element indicative of the second user executing the transaction document.

Processing logic can generate, based on accessing the data indicative of the second user input, fourth instructions that are executable by one or more processors of one or more third client devices to automatically update the graphical user interface of the one or more third client devices to provide for display a notification indicating completion of the transaction document.

In some implementations, the systems and methods described herein can include a compliance engine database including a number of compliance rules. Each respective rule can be associated with at least one of: (i) a jurisdiction or (ii) a client identifier.

Processing logic can receive a request for a transaction document. The request is associated with the jurisdiction and the client identifier.

Processing logic can query the compliance engine database to identify a subset of the plurality of compliance rules associated with the jurisdiction and the client identifier. In some cases, processing logic can process, by a machine-learned model, input comprising data associated with the client identifier to generate output comprising: (i) a stipulation recommendation and (ii) a confidence score. For instance, input data can include an input vector. In some instances, the output of the machine-learned model can further include: (i) an estimated net recovery for stipulation and (ii) an estimated net recovery for litigation. In some cases, an output from the model can include an actionable output. For instance, an actionable output can include “proceed with stipulation agreement” or “proceed with litigation.” This utilization of machine-learning provides a specific application of a computational tool to transform historical data into forward-looking guidance which can enable a more data-driven and efficient computer-managed resolution process.

Processing logic can generate the transaction document by modifying a template document based on the identified subset of the plurality of compliance rules. For instance, processing logic can query a database including data associated with the client identifier. The data associated with the client identifier comprises at least one of: (i) an account age, (ii) a debt principal, (iii) a debt type, (iv) a consumer credit score, (v) a consumer payment history, (vi) a historical stipulation success rate, (vii) estimated litigation costs. Processing logic can modify, based on the data associated with the client identifier, one or more fields associated with the template document.

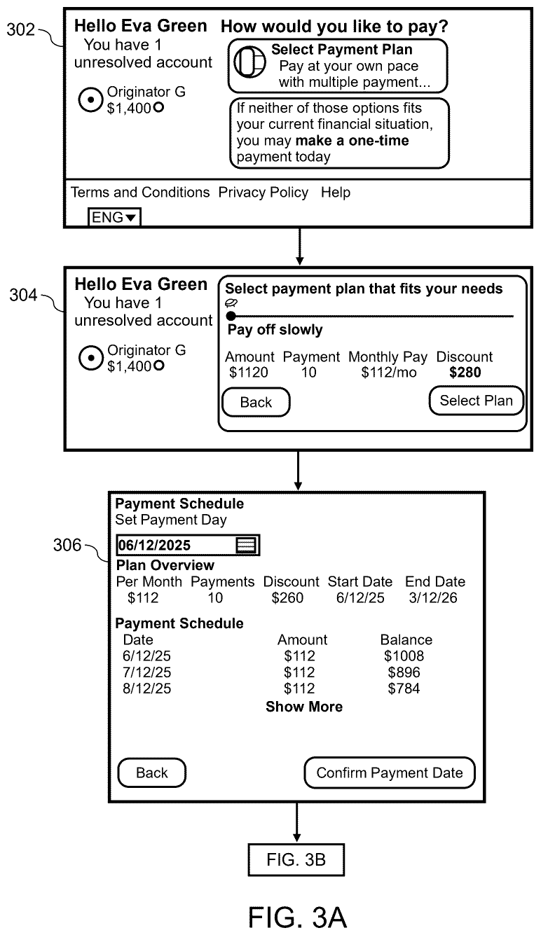

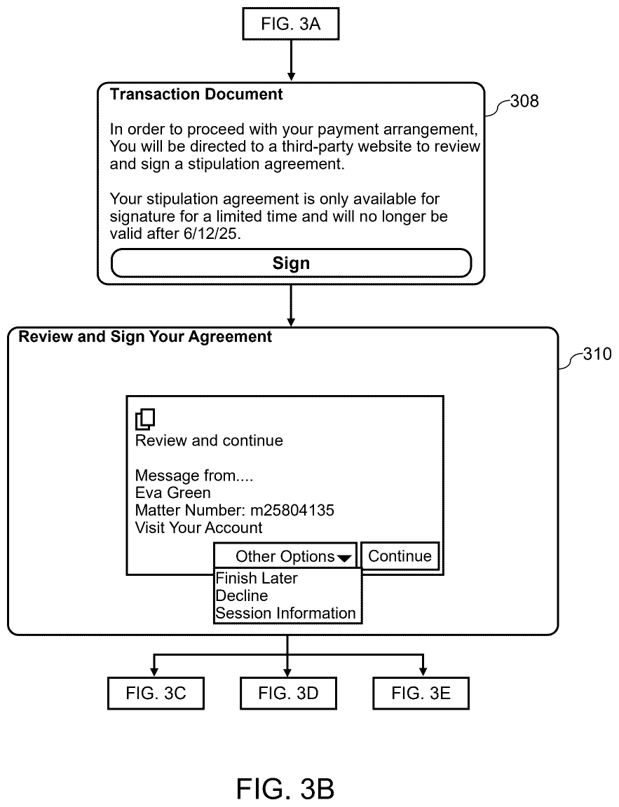

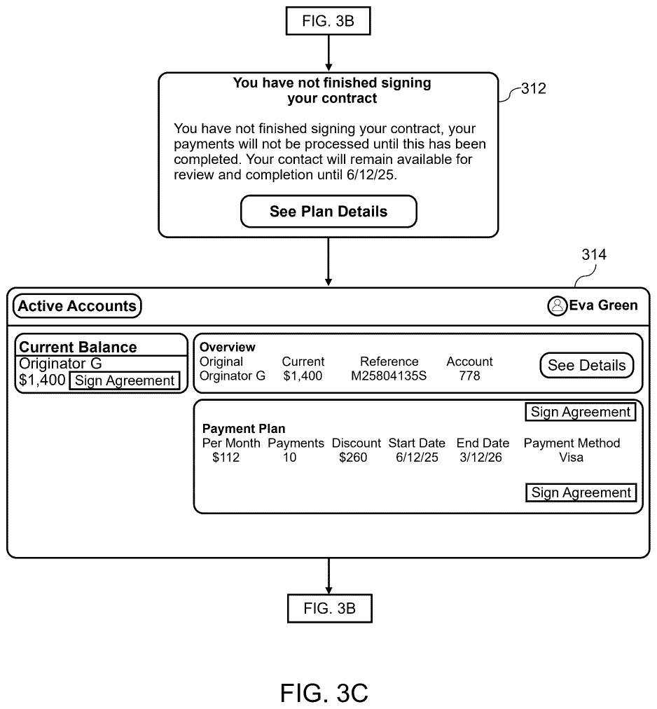

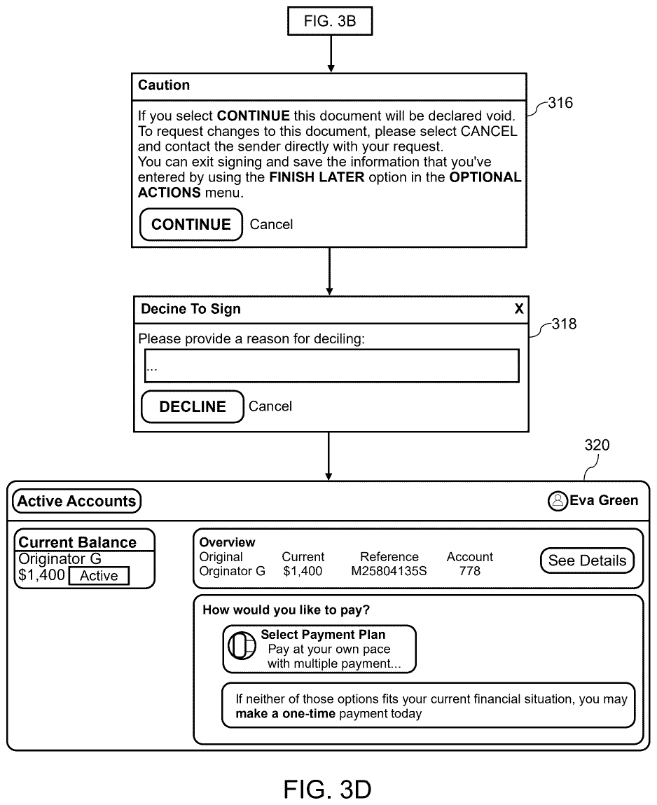

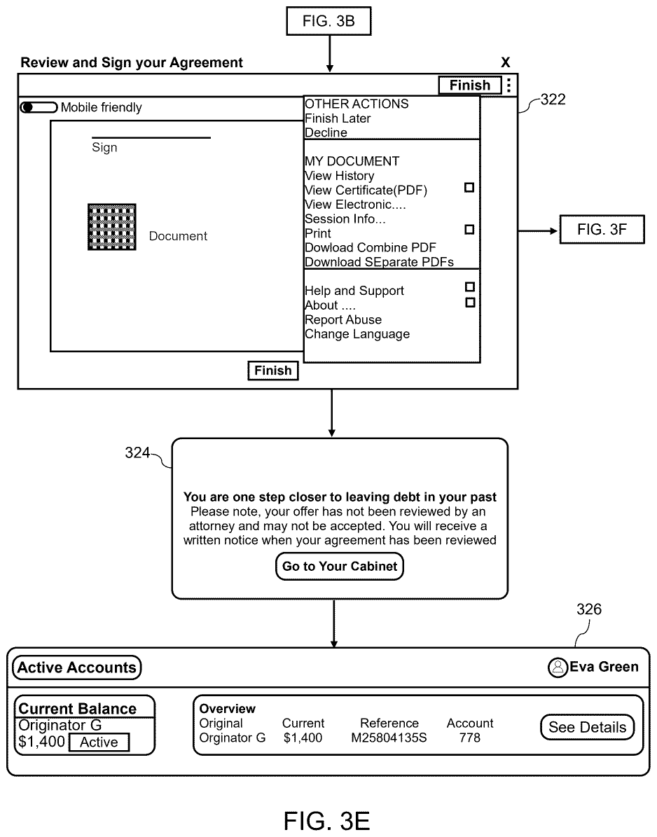

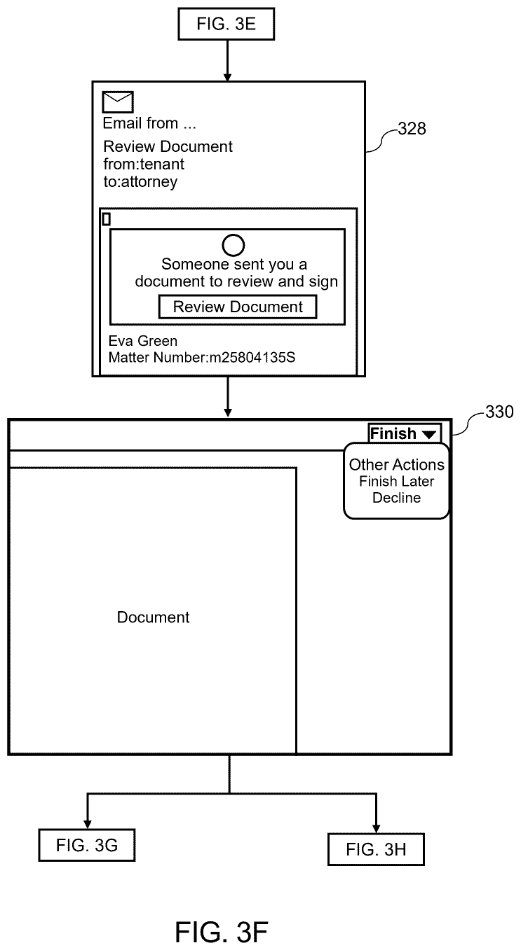

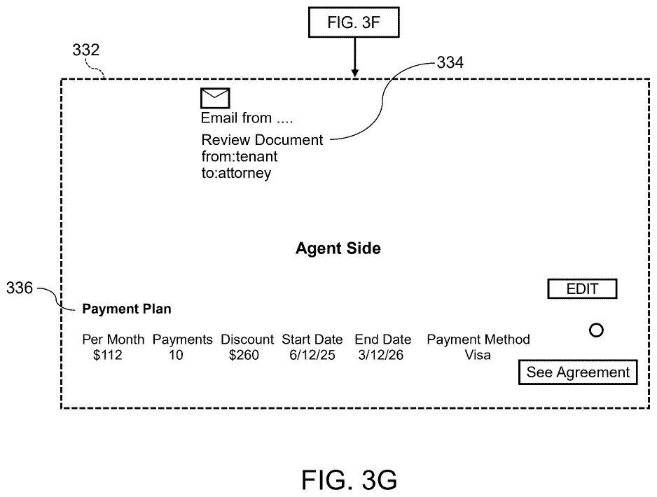

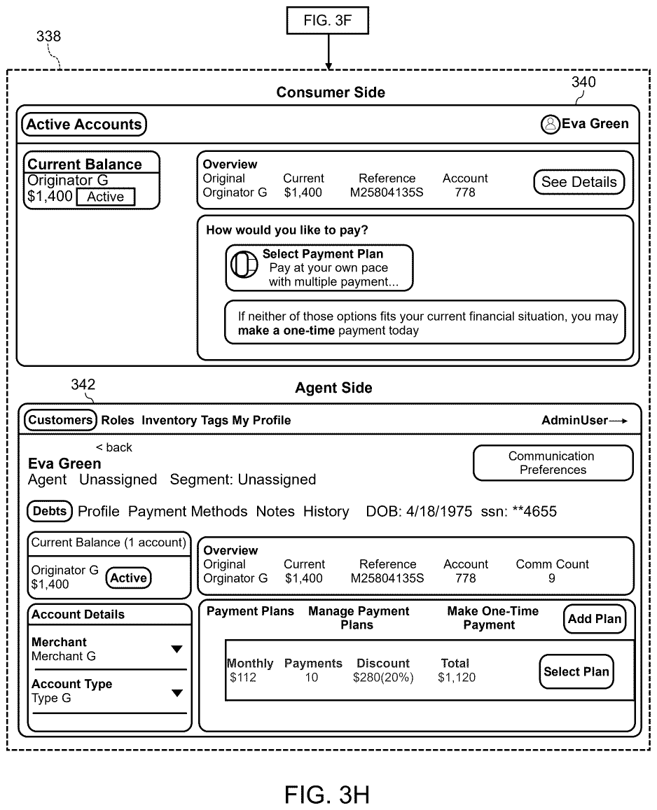

FIGS. 3A-3H illustrate an example user interface workflow for a dynamic document generation and execution system. The example user interfaces can be provided for display via a user device associated with a first user, second user, agent user, or other user with access to various account updates or interactive user interface elements.

FIG. 3A illustrates a series of graphical user interfaces that can be presented on a client device to a first user. The graphical user interfaces can include a payment plan initiation interface 302, a payment plan selection interface 304, and a payment plan confirmation interface 306.

Payment plan initiation interface 302 can be a screen that provides a personalized greeting to an authenticated user and can present one or more interactive elements to initiate a payment process. It can include a user interface element that upon selection, can guide a user to payment plan selection interface 304.

Payment plan selection interface 304 can be a screen that displays one or more payment plan options. Each option can display details such as a total amount, a number of payments, a monthly payment amount, and any applicable discount. The user interface can include an interactive element, such as a “Select Plan” button, for the user to make a selection. Based on this selection, the payment plan confirmation interface 306 can be displayed.

Payment plan confirmation interface 306 can be a screen that displays a summary of the selected payment plan, which can include a plan overview, a payment schedule with dates and amounts, and a final payment date. This interface can include an interactive element, such as a “Confirm Payment Date” button, that a user can select to proceed to the next step in the workflow depicted in FIG. 3B.

FIG. 3B illustrates graphical user interfaces for initiating the signing of a generated agreement. The Transaction document user interface 308 can be a modal window or pop-up that can be displayed after a user confirms a payment plan. This interface can inform the user that proceeding requires the execution of a transaction document, which may be handled by a third-party service. It may also indicate a time limit for the validity of the signature link. An interactive element, such as a “Sign” button, can be provided. The Review and Sign Your Agreement user interface 310 can be an interface, for instance, an embedded viewer from a third-party electronic signature service, which displays the generated transaction document. This interface can provide interactive elements that allow a user to execute the agreement, decline the agreement, or save the session to finish at a later time.

If a user saves the session to finish at a later time, the process can progress to FIG. 3C. If the user declines the agreement, the process can progress to FIG. 3D. If the user executes the agreement, the process could progress to FIG. 3E.

FIG. 3C illustrates a workflow for a user who opts to finish signing later. The You have not finished signing your contract user interface 312 can be a notification displayed to a user, informing them that the signing process is incomplete and that the agreement will remain available for a specified period. The Consumer Side user interface 314 can be a view within a user's account portal or dashboard. This interface can display an overview of the account and the selected payment plan, and it can include an interactive element, such as a “Sign Agreement” button, which can allow the user to re-enter the signing workflow. Upon selection of the “sign agreement” button, the graphical user interface can be updated to display the Transaction document user interface 308 as depicted in FIG. 3B.

FIG. 3D illustrates a workflow for a user who declines to sign the agreement. The Caution user interface 316 can be a pop-up or modal window that can ask the user to confirm their intention to decline, which may result in the document being declared void. This interface can provide interactive elements such as “Continue” to proceed with declining or “Cancel” to return to the previous step. The Decline to Sign user interface 318 can be an interface that prompts the user to provide a reason for declining the agreement. This can include a text input field where the user can enter an explanation. Providing a reason can be an optional or required step. User input provided can be used to intelligently update the agreement to fix errors in real-time or near real-time as described herein. The You have declined the agreement user interface 320 can be a confirmation screen displayed after the user has submitted their rejection, which may also present alternative payment options.

FIG. 3E illustrates a workflow for a user who successfully signs the agreement. The Review and Sign Your Agreement user interface 322 can be the document signing interface where a user can provide their electronic signature and select a final confirmation element, such as a “Finish” button. Upon selection of the “Finish” button, the user interface for the user can be updated. Additionally, the system can proceed with notifications to one or more second party reviewer users as depicted in FIG. 3F.

The You are one step closer to leaving debt in your past user interface 324 can be a confirmation screen indicating that the user's part of the signing process is complete and the agreement has been routed for further action. It may include an interactive element, such as a “Go to Your Cabinet” button, to return the user to their main account view. The Consumer Side user interface 326 can be a view within the user's account portal that displays the status of the agreement. For example, it may show a status indicator such as “Pending Agreement” to signify that the document is awaiting a counter-signature.

FIG. 3F illustrates the initiation of the second party's review process. The Email from DocuSign user interface 328 can be an electronic notification, such as an email, sent to a second user, for example, an attorney. The notification can inform the recipient that a document is ready for their review and signature and can include an interactive element, such as a “Review Document” link to access the agreement. The Finish user interface 330 can be the document signing interface as presented to the second party. It can display the agreement, now including the first party's signature, and can provide interactive user interface elements for the second party to execute the agreement, decline it, or postpone the action.

If a user executes the agreement, the process can proceed as depicted in FIG. 3G. If the user declines the agreement, the process can proceed as depicted in FIG. 3H.

FIG. 3G illustrates the workflow when the second party executes the agreement. The Agent side user interface 332 can be a container for views within a portal used by an agent or attorney. The DocuSign Email Notification user interface 334 can be a notification, for example an email, which can be sent to all involved parties to confirm that the agreement has been completed and fully executed. The Payment Plan user interface 336 can be a view within an administrative or agent-side system that displays the details of the now-active payment plan. This view can show information such as the payment amount, the number of payments, the plan type, start and end dates, and the payment method. It may also include interactive elements to view the executed agreement.

FIG. 3H illustrates the workflow when the second party declines the agreement. The Consumer Side user interface 338 can be a container for a notification shown to the consumer. The Consumer Side notification user interface 340 can be a view within the first user's portal that displays a message indicating that the agreement was not approved by the second party. The notification may also provide contact information for assistance. The Agent Side user interface 342 can be a view within the administrative or agent-side system that displays the details for the consumer's account. This view can reflect the declined status of the transaction document and may provide tools for an agent to manage the account. For instance, the agent may be able to see reasons why the transaction document was declined by the attorney, for instance, for including a problematic provision. As such, the agent can initiate an updated agreement being generated and executed by the parties.

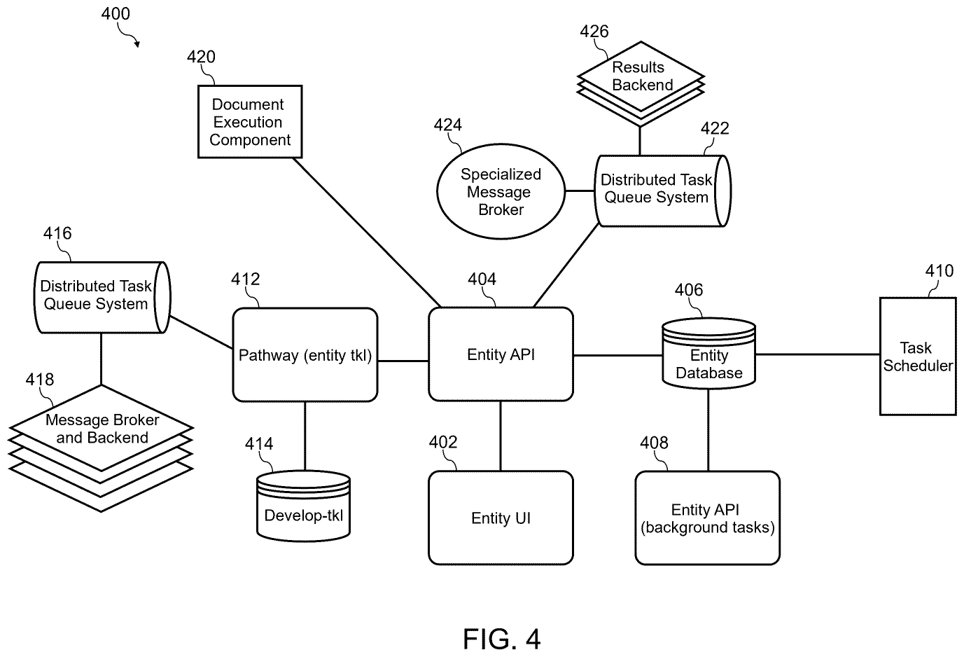

FIG. 4 illustrates an example implementation of a system architecture 400. The system architecture 400 can include an entity UI 402, an entity API 404, an entity database 406, an entity API (background tasks) 408, a task scheduler 410, a pathway (entity tkl) 412, a develop-tkl 414, a first distributed task queue system 416, a message broker and backend 418, a document execution component 420, a second distributed task queue system 422, a specialized message broker 424, and a result backend 426. The components can be communicatively coupled via one or more networks to perform various data processing and task management functions.

An entity UI 402 can be a user interface component. For example, the entity UI 402 can be a graphical user interface rendered in a web browser or a native application that provides for user interaction with the system. The entity UI 402 can be in communication with an entity API 404. The entity API 404 can be an application programming interface that provides a set of endpoints for interacting with the system. For example, the entity API 404 can process requests from the entity UI 402 and orchestrate communications with other components, such as an entity database 406, a pathway (entity tkl) 412, a document execution component 420, a distributed task queue system 422, and a specialized message broker 424. An entity database 406 can be a data storage component. For example, the entity database 406 can be a relational, non-relational, or other type of database configured to store data. The entity database 406 can be in communication with the entity API 404, an entity API (background tasks) 408, and a task scheduler 410. An entity API (background tasks) 408 can be an application programming interface configured to handle background processing. For example, the entity API (background tasks) 408 can perform asynchronous operations or maintenance tasks and may communicate with the entity database 406.

A task scheduler 410 can be a component for scheduling automated jobs or tasks. For example, the task scheduler 410 can be a cron job daemon or a dedicated scheduling service that initiates processes based on time or events. The task scheduler 410 can be in communication with the entity database 406. A pathway (entity tkl) 412 can be a processing module or service. In some instances, a pathway (entity tkl) can be a workflow management component. For example, the pathway (entity tkl) 412 can be configured to execute a specific workflow or a set of tasks based on instructions from the entity API 404. The pathway (entity tkl) 412 can be in communication with the entity API 404, a develop-tkl 414, and a distributed task queue system 416. A develop-tkl 414 can be a data storage component. For example, the develop-tkl 414 can be a database or file store used by the pathway (entity tkl) 412. A distributed task queue system 416 can be a component for managing and distributing tasks to worker processes. For example, the distributed task queue system 416 can be an implementation of a task queue framework that receives tasks from the pathway (entity tkl) 412 and manages their execution via a message broker and backend 418. The message broker and backend 418 can be a component that facilitates communication between task producers and consumers. For example, the message broker and backend 418 can include a message queuing service and a result store.

A document execution component 420 can be a processing module configured to handle document-related operations. For example, the document execution component 420 can manage the generation, signing, or processing of electronic documents. The document execution component 420 can be in communication with the entity API 404. A distributed task queue system 422 can be another component for managing and distributing tasks. For example, the distributed task queue system 422 can handle a different set of tasks than the distributed task queue system 416 and may receive tasks from the entity API 404 via a specialized message broker 424. The distributed task queue system 422 can also store task outcomes in a result backend 426. A specialized message broker 424 can be a message-oriented middleware component. For example, the specialized message broker 424 can be configured to route messages between the entity API 404 and the distributed task queue system 422. A result backend 426 can be a data storage system. For example, the result backend 426 can be a database or cache configured to store the results of tasks executed by the distributed task queue system 422.

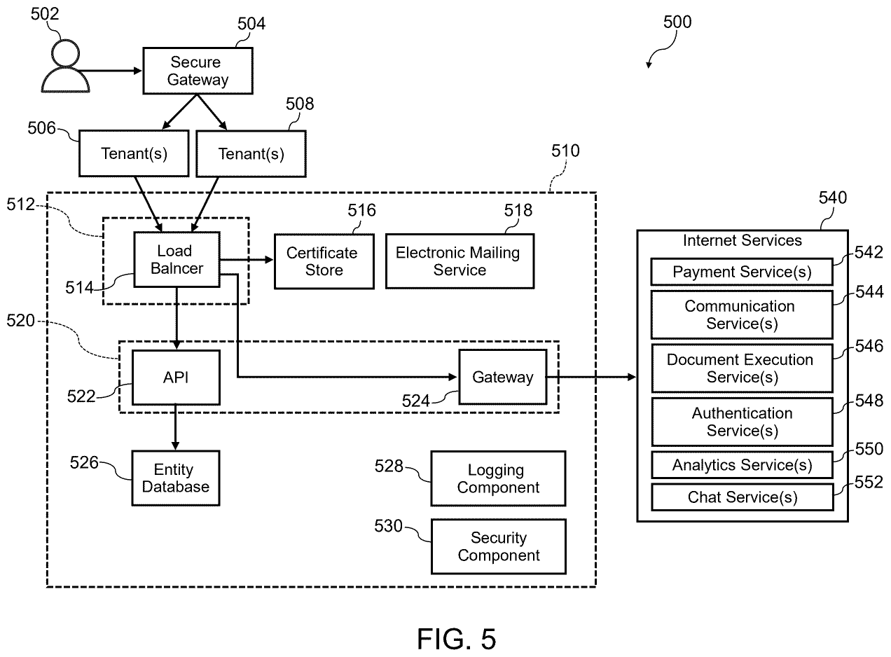

FIG. 5 illustrates an example implementation of a system architecture 500. The system architecture 500 can include a user 502, who can interact with a secure gateway 504. The secure gateway 504 can communicate with one or more tenant(s) 506 and tenant(s) 508. These tenants can, in turn, interact with an application infrastructure represented within system boundary 510. This infrastructure can include a load balancer 514 which can direct traffic to components such as an API 522 and a gateway 524. The system architecture 500 can also include a certificate store 516, an electronic mailing service 518, an entity database 526, a logging component 528, and a security component 530. The gateway 524 can communicate with a collection of internet services 540, which may include payment service(s) 542, communication service(s) 544, document execution service(s) 546, authentication service(s) 548, analytics service(s) 550, and chat service(s) 552. The diagram also illustrates logical groupings, such as logical grouping 512 and logical grouping 520.

The system architecture 500 can receive input from a user 502. The user 502 can be, for example, a person operating a client computing device to access the system. The user 502 can communicate with a secure gateway 504. A secure gateway 504 can be a component that acts as an entry point to the system, providing a layer of security. For example, a secure gateway 504 can be a web application firewall or a reverse proxy. The secure gateway 504 can route requests to one or more tenant(s) 506 and tenant(s) 508. Tenant(s) 506 and tenant(s) 508 can be isolated instances of an application or computing environment, which may be provisioned for different customers or organizational units. The application infrastructure within system boundary 510 can include several components. Tenant(s) 506 and tenant(s) 508 can communicate with a load balancer 514. A load balancer 514 can be a component that distributes incoming network traffic across multiple backend servers or services. For example, a load balancer 514 can be a hardware appliance or a software-based router. The load balancer 514 can be in communication with a certificate store 516. A certificate store 516 can be a repository for storing and managing digital certificates, such as SSL/TLS certificates used for securing network communications. The system architecture 500 can also include an electronic mailing service 518. An electronic mailing service 518 can be a component responsible for sending, receiving, or managing electronic mail. For example, this can be an SMTP service or an API to a third-party email provider.

The load balancer 514 can route traffic to an API 522 and a gateway 524. A logical grouping 512 may represent the combination of the load balancer 514 and the API 522. An API 522 can be an application programming interface that defines endpoints for application functionalities. For example, an API 522 can be a RESTful API that exposes business logic to client applications. The API 522 can be in communication with an entity database 526. An entity database 526 can be a data storage system for persisting application data. For example, an entity database 526 can be a relational, document, or key-value database. A logical grouping 520 may represent the combination of the API 522 and the entity database 526. A gateway 524 can be a component that acts as an intermediary for requests seeking access to other services. For example, a gateway 524 can be an API gateway that routes requests to various external or microservice-based internet services 540.

The system architecture 500 can also include a logging component 528 and a security component 530. A logging component 528 can be a module or service that collects and stores log data from various parts of the system. For example, a logging component 528 can aggregate application logs, system logs, and access logs. A security component 530 can be a module or service that handles security-related functions. For example, a security component 530 can manage user authentication, authorization, or intrusion detection.

The gateway 524 can be in communication with a collection of internet services 540. Internet services 540 can represent one or more external, third-party services. These can include payment service(s) 542, which can be, for example, a service for processing financial transactions. They can also include communication service(s) 544, which can be, for example, a service for sending SMS or voice notifications. Also included can be document execution service(s) 546, for example, an electronic signature platform. Authentication service(s) 548 can be provided, for example, by a third-party identity provider. Analytics service(s) 550 can be, for example, a service for tracking application usage and metrics. Chat service(s) 552 can be, for example, a platform for providing real-time chat functionality

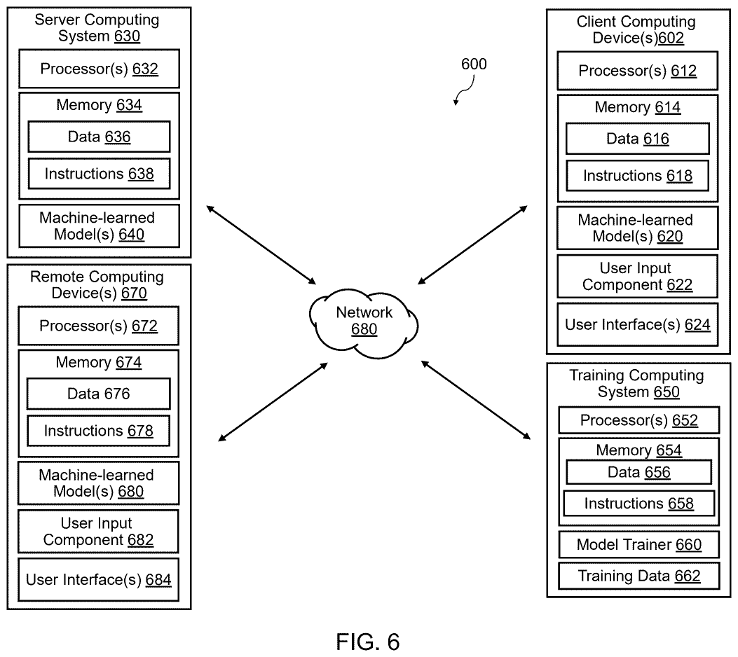

FIG. 6 depicts a block diagram of an example computing system 600 that performs a transaction document generation scheme according to example embodiments of the present disclosure. The computing system can include one or more computing system(s)/device(s) such as, for example, one or more user computing device(s) 602, one or more server computing system(s) 630, one or more training computing system(s) 650, one or more remote computing device(s) 670, and/or any other computing devices/systems associated with natural language processing or document generation. Each of the device(s)/system(s) are communicatively coupled over a network 680.

The user computing device(s) 602 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 602 includes one or more processors 612 and a memory 614. The one or more processors 612 can be any suitable processing device (e.g., a processor core, a microprocessor, an ASIC, an FPGA, a controller, a microcontroller, etc.) and can be one processor or a plurality of processors that are operatively connected. The memory 614 can include one or more non-transitory computer-readable storage media, such as RAM, ROM, EEPROM, EPROM, flash memory devices, magnetic disks, etc., and combinations thereof. The memory 614 can store data 616 and instructions 618 which are executed by the processor 612 to cause the user computing device 602 to perform operations. The data can include, for example, image data indicative of a plurality of court judgments, judgment data indicative of one or more verified features of the court judgments, user input data, ground truth data, etc.

In some implementations, the user computing device 602 can store or include one or more machine-learned model(s) 620. For example, the machine-learned model(s) 620 can be or can otherwise include various machine-learning models such as neural networks (e.g., deep neural networks) or other types of machine-learning models, including non-linear models and/or linear models. Neural networks can include feed-forward neural networks, recurrent neural networks (e.g., long short-term memory recurrent neural networks), convolutional neural networks or other forms of neural networks. Some example machine-learning models can leverage an attention mechanism such as self-attention. For example, some example machine-learning models can include multi-headed self-attention models (e.g., transformer models).

In some instances, machine-learned models can include large language models. Large language models can include models capable of generating human-quality text, translating languages, writing different kinds of creative content, and answering your questions in an informative way. These models are trained on massive datasets of text and code, enabling them to learn complex patterns and relationships in language. The size and complexity of the machine-learned models can vary to provide for natural language processing task performance.

In some implementations, the one or more machine-learned model(s) 620 can be received from the server computing system 630 over network 680, stored in the user computing device memory 614, and then used or otherwise implemented by the one or more processors 612. In some implementations, the user computing device 602 can implement multiple parallel instances of a single machine-learned model 620 (e.g., to perform parallel image processing across multiple instances of the machine-learned model 620).

In some instances, the machine-learned model(s) 620 can include one or more machine-learning image classification model(s). By way of example, the image classification model(s) can be learning to take one or more documents as input and, in response, output an image classification corresponding to the one or more documents. An image classification, for example, can be indicative of a document type for the one or more documents. The document type can identify a category associated with the document(s). As one example, the document type can be indicative of an entity that issued the document(s) such as, for example, a county, state, municipality, district, or court associated with the document(s). In addition, or alternatively, the document type can identify a template associated with the document(s). For instance, the document type can be indicative of one or more templates, formats, features, etc. associated with the document(s) that are common to a group of the plurality of documents. In this manner, the document type can match the document(s) to an identifiable group of documents sharing one or more common aspects.

In addition, or alternatively, the machine-learned model(s) 620 can include one or more machine-learning element extraction model(s). The one or more element extraction model(s) can include one or more machine-learning optical recognition model(s), one or more machine-learning intelligent character recognition model(s), and/or any other machine-learning model capable of recognizing features of a document. The element extraction model(s) can be trained to identify feature(s) of a document and generate a corresponding element (e.g., a prediction) for the feature.

In some implementations, one or more machine-learned model(s) 640 can be included in or otherwise stored and implemented by the server computing system 630 that communicates with the user computing device 602 according to a client-server relationship. For example, the machine-learned model(s) 640 can be implemented by the server computing system 630 as a portion of a web service (e.g., a tiered image processing service). Thus, one or more models 620 can be stored and implemented at the user computing device 602 and/or one or more models 640 can be stored and implemented at the server computing system 630.

The client computing system 602 can include one or more of user input component 622 and/or user interface(s) 624. The client computing system 602 can obtain user input via user input component 622. The user interface(s) 624 associated with client computing system 602 can be updated to guide a user through the transaction document generation, updating, or execution according to example embodiments described herein.

The server computing system 630 includes one or more processors 632 and a memory 634. The one or more processors 632 can be any suitable processing device (e.g., a processor core, a microprocessor, an ASIC, an FPGA, a controller, a microcontroller, etc.) and can be one processor or a plurality of processors that are operatively connected. The memory 634 can include one or more non-transitory computer-readable storage media, such as RAM, ROM, EEPROM, EPROM, flash memory devices, magnetic disks, etc., and combinations thereof. The memory 634 can store data 636 and instructions 638 which are executed by the processor 632 to cause the server computing system 630 to perform operations. The data can include, for example, data associated with statutes, rules, agreements, terms of service, one or more verified features of the agreements, user input data, ground truth data, etc.

In some implementations, the server computing system 630 includes or is otherwise implemented by one or more server computing devices. In instances in which the server computing system 630 includes plural server computing devices, such server computing devices can operate according to sequential computing architectures, parallel computing architectures, or some combination thereof.

As described above, the server computing system 630 can store or otherwise include one or more machine-learned model(s) 640. For example, the models 640 can be or can otherwise include various machine-learning models. Example machine-learning models include neural networks or other multi-layer non-linear models. Example neural networks include feed forward neural networks, deep neural networks, recurrent neural networks, and convolutional neural networks. Some example machine-learning models can leverage an attention mechanism such as self-attention. For example, some example machine-learning models can include multi-headed self-attention models (e.g., transformer models).

The user computing device 602 and/or the server computing system 630 can train the models 620 and/or 640 via interaction with the training computing system 650 that is communicatively coupled over the network 680. The training computing system 650 can be separate from the server computing system 630 or can be a portion of the server computing system 630.

The training computing system 650 includes one or more processors 652 and a memory 654. The one or more processors 652 can be any suitable processing device (e.g., a processor core, a microprocessor, an ASIC, an FPGA, a controller, a microcontroller, etc.) and can be one processor or a plurality of processors that are operatively connected. The memory 654 can include one or more non-transitory computer-readable storage media, such as RAM, ROM, EEPROM, EPROM, flash memory devices, magnetic disks, etc., and combinations thereof. The memory 654 can store data 656 and instructions 658 which are executed by the processor 652 to cause the training computing system 650 to perform operations. The data can include, for example, image data indicative of a plurality of court judgments, judgment data indicative of one or more verified features of the court judgments, user input data, ground truth data, etc. In some implementations, the training computing system 650 includes or is otherwise implemented by one or more server computing devices.

The training computing system 650 can include a model trainer 660 that trains the machine-learning machine-learned models 620 and/or 640 stored at the user computing device 602 and/or the server computing system 630 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations. An example loss function, for example, can be defined based on an accuracy of the machine-learned models 620 and/or 640 when applied to different types of document(s).

In some implementations, performing backwards propagation of errors can include performing truncated backpropagation through time. The model trainer 660 can perform a number of generalization techniques (e.g., weight decays, dropouts, etc.) to improve the generalization capability of the models being trained.

In particular, the model trainer 660 can train the machine-learned model(s) 620 and/or 640 based on a set of training data 662. For example, in some implementations, the machine-learning image classification model(s) (e.g., a judgment classification model) can be trained over at least a portion of training data 662 (e.g., via one or more supervised training techniques). The training data 662 can include, for example, information stored in a document (e.g., judgment) database (and/or any other datastore). The training data 662 can include a plurality of labelled images (e.g., depicting one or more documents such as court judgments, etc.). Each labelled image can be associated with one or more labels indicative of a judgment type, county, state, district, court, and/or any other classification associated with the labelled image. The one or more labels can include ground truths for training the machine-learning image classification model(s). In such a case, the labelled images can be input to the machine-learning judgment classification model(s) and the model(s) can be trained, via back propagation of errors, to output classifications based on the ground truths.

As another example, in some implementations, the machine-learning element extraction model(s) can be trained via representative sampling. As an example, the training data 662 can include one or more ground truth elements corresponding to one or more representative features of a document. The model(s) can obtain one or more ground truths (e.g., valid elements corresponding to features of a document from the training database, etc.) corresponding to training data (e.g., image data utilized for training) indicative of one or more randomly selected documents (e.g., from a document/judgment database), one or more training documents (e.g., from the training database, etc.), etc. The training computing system 650 (e.g., model trainer 660) can utilize the transaction document generation scheme to determine one or more training elements from the training data. The training computing system 650 can compare the one or more training elements to the one or more ground truths to determine an accuracy of the transaction document generation scheme and/or one or more element extraction model(s) of the transaction document generation scheme. The training computing system 650 can update one or more model parameters to increase the performance (e.g., accuracy, etc.) of the model(s).

In some instances, model trainer 660 can perform model fine-tuning to tune the model for particular use cases or client preferences.

The model trainer 660 includes computer logic utilized to provide desired functionality. The model trainer 660 can be implemented in hardware, firmware, and/or software controlling a general purpose processor. For example, in some implementations, the model trainer 660 includes program files stored on a storage device, loaded into a memory and executed by one or more processors. In other implementations, the model trainer 660 includes one or more sets of computer-executable instructions that are stored in a tangible computer-readable storage medium such as RAM, hard disk, or optical or magnetic media.

In some implementations, the system 600 can include one or more remote computing device(s) 670 (e.g., remote user computing device(s)). Each of the one or more remote computing device(s) 670 include one or more processors 672 and a memory 674. The one or more processors 672 can be any suitable processing device (e.g., a processor core, a microprocessor, an ASIC, an FPGA, a controller, a microcontroller, etc.) and can be one processor or a plurality of processors that are operatively connected. The memory 674 can include one or more non-transitory computer-readable storage media, such as RAM, ROM, EEPROM, EPROM, flash memory devices, magnetic disks, etc., and combinations thereof.

The memory 674 can store data 676 and instructions 678 which are executed by the processor 672 to cause the remote computing device(s) 670 to perform operations. Remote computing device(s) 670 can include user input component 682 to obtain user input data. Remote computing device(s) 670 can include user interface(s) 684 to be updated based on user input and/or operations performed by remote computing device(s).

The user computing device(s) 602 and/or the remote computing device(s) 670 can include one or more user input components 622, 682 that receive user input. For example, the user input components 622, 682 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The network 680 can be any type of communications network, such as a local area network (e.g., intranet), wide area network (e.g., Internet), or some combination thereof and can include any number of wired or wireless links. In general, communication over the network 680 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

The machine-learning models described in this specification may be used in a variety of tasks, applications, and/or use cases.

In some implementations, the input to the machine-learning model(s) 620, 640 of the present disclosure can be transaction document data (e.g., document(s), agreements(s), statutes, rules, etc.). The machine-learning model(s) 620, 640 can process the transaction document data to generate an output. As an example, the machine-learning model(s) 620, 640 can process the input data to generate a transaction document.

In some implementations, the input to the machine-learning model(s) 620, 640 of the present disclosure can be text or natural language data. The machine-learning model(s) 620, 640 can process the text or natural language data to generate an output. As an example, the machine-learning model(s) 620, 640 can process the natural language data to generate a language encoding output. As another example, the machine-learning model(s) 620, 640 can process the text or natural language data to generate a latent text embedding output. As another example, the machine-learning model(s) 620, 640 can process the text or natural language data to generate a translation output. As another example, the machine-learning model(s) 620, 640 can process the text or natural language data to generate a classification output.

FIG. 6 illustrates one example computing system that can be used to implement the present disclosure. Other computing systems can be used as well. For example, in some implementations, the user computing device 602 can include the model trainer 660 and the training dataset 662. In such implementations, the model(s) 620 can be both trained and used locally at the user computing device 602. In some of such implementations, the user computing device 602 can implement the model trainer 660 to personalize the models 620 based on user-specific data.

In the legal collections space, stipulations represent a more efficient, cost-effective, and consumer-centric alternative to suit filing. The stipulation process described herein is designed to streamline the creation, review, and execution of these agreements. This can include leveraging automation, advanced workflows, and intelligent feedback systems. This study provides a detailed examination of the stipulation process, incorporating insights from several process flow diagrams, associated Jira tasks, and industry context, to demonstrate how this innovation offers a competitive edge and the potential to transform the industry. Additionally, the disclosure described herein describes a number of technical effects and benefits that reflect improvements in computing systems and improvements in machine-learning technology.

The stipulation process can provide for simplification of debt resolution for consumers while optimizing efficiency and compliance for creditors. By offering consumers a seamless way to select, confirm, and sign repayment agreements, the system can reduce friction, accelerate resolutions, and ensure legal accuracy. Decision points involving consumers and attorneys can fully integrated into the workflow, with automated tracking and reporting providing actionable insights to enhance the process. The platform's intelligent feedback loop can capture and analyze rejection reasons, contributing to continuous system improvements while ensuring high user satisfaction. As such, the continuous system improvements can provide for reduction in compute resource utilization due to better generation of output by the machine-learned models used to generate the transaction documents and facilitate execution of such agreements.

In some implementations, the process flow can include consumer engagement, electronic transaction document creation, attorney review, and execution and feedback.

Consumer Engagement can include a user accessing or otherwise logging into an account associated with a service provider platform. The system can provide the user with accesses to one or more interactive user interface(s) which can display repayment plans tailored to their unique situation. These plans can be dynamically generated using advanced AI-driven machine learning algorithms that account for client-specific constraints, legal compliance requirements, historical repayment behaviors, and predictive measures of repayment success and potential breakage. This can provide for the consumer to be presented with an optimized, manageable repayment solution designed to maximize the likelihood of success while adhering to all relevant guidelines.

The system can obtain data indicative of consumer inputs of payment information and selects a payment date.

Electronic Transaction document Creation can be performed by the system upon receipt of confirmation data obtained by user input. Upon confirmation, the system can generate a Transaction document, prompting the consumer to e-sign.

In some implementations, the consumer can sign. The system can transition the agreement to a “Pending” state and route or otherwise transmit to a device associated with an attorney's review queue. If the consumer opts out, they are redirected to review alternative plans, maintaining their engagement.

Attorney Review can include providing the Transaction document for display to the attorney via the computing device associated with the attorney. The attorney can review the Transaction document to ensure it complies with legal standards and meets client expectations.

In some instances, the system can be integrated with an electronic signature service to provide for secure and compliant electronic signatures, eliminating manual inefficiencies.

The system automatically assigns a task to the attorney, prompting them to review the stipulation and execute the document (via the user interface associated with the computing device of the attorney). This task can be timebound and monitored to prevent agreements from lapsing, ensuring timely resolution. In some instances, the systems and methods described herein can provide for a mobile-first design to allow for an improved human-machine interface providing attorneys unparalleled flexibility, whether they prefer to conduct their review at a desktop in their office or on a mobile device while on the move. This flexibility enables attorneys to maintain productivity without sacrificing thoroughness or legal accuracy.

The system can obtain user input including approval of an agreement that can be e-signed by the attorney, finalized, and/or retained. The corresponding repayment plan can immediately be accessible to the consumer in the interactive user interface.

Execution and Feedback can include intelligent monitoring to capture all decision outcomes, providing actionable insights for optimization. Rejection causes from either consumers or attorneys can be categorized and analy zed in detailed optimization reports to refine workflows and improve outcomes. As such, the models used to generate the transaction document or make suggestions regarding the transaction document can be tuned or otherwise trained using a feedback loop to provide for better models that produce better output.

The systems provided herein can allow for tailored workflows to accommodate specific client needs, ensuring scalability and adaptability to diverse requirements.

In some implementations the system features can provide distinct advantages for clients and reflect a sophisticated architecture. Features can include: (i) Integration with document signing service: Streamlines e-signature functionality, (ii) Real-Time Feedback Loop: Captures, categorizes, and analyzes rejection causes to dynamically refine system performance; (iii) Scalable Solutions: Clients can tailor agreements to specific needs, such as unique stipulation formats; (iv) Dynamic Testing Environment: Testing workflows in demo tenants ensures robust client delivery; or (v) Data Accessibility: Real-time access to PDF stipulations enhances transparency and user trust.

Additionally, or alternatively, the systems and methods described herein can include (i) System Intelligence: optimization reports generated from feedback leverage advanced AI and machine learning to suggest automated refinements, ensuring the platform evolves continuously or (ii) technical sophistication: the underlying technical infrastructure of the stipulation process described herein is both innovative and exceptionally complex.

Features can include: (i) microservices architecture: each stage of the stipulation workflow operates independently, enabling high scalability and fault isolation; (ii) AI-powered decision engines: machine learning algorithms analyze patterns and propose changes to workflows or system parameters, reducing errors and improving approval rates; (iii) real-time data processing: high-throughput processing ensures immediate feedback for both consumers and attorneys, minimizing delays; or (iv) multi-tenant environment: the platform supports multiple clients with isolated data environments, ensuring security and compliance while maintaining flexibility.

In some implementations, the systems and methods described herein can include intelligent monitoring and alerts: a real-time monitoring system identifies anomalies, such as repetitive rejection reasons, and triggers alerts for proactive resolution.

Benefits associated with the described system and methods can include Cost and Time Efficiency. By reducing the need for lawsuits, the provider's stipulation process significantly lowers costs and accelerates resolution times. Automated workflows eliminate manual bottlenecks, enabling clients to focus on higher-value activities.

Benefits associated with the described system and methods can include Enhanced Compliance. Attorney oversight and intelligent monitoring ensure that all agreements meet regulatory and legal standards. Real-time error capture and feedback reduce risks associated with non-compliance.

Benefits associated with the described system and methods can include Improved Consumer Experience. The transparency and flexibility of the platform can encourage consumer engagement and repayment. Consumers are more likely to agree to stipulations due to tailored payment plans and clear communication.

Benefits associated with the described system and methods can include Scalability and Customization. The provider's intelligent workflows can be designed to handle large volumes of stipulations with minimal human intervention, making the process scalable for clients managing diverse portfolios. Custom client solutions can demonstrate the system's adaptability and appeal.

Benefits associated with the described system and methods can include the integration of automated workflows, advanced attorney oversight, real-time monitoring, and/or AI-driven optimization reports. This can allow for improved to provide clients unparalleled market advantages in addition to the numerous computing efficiencies and technical effects and benefits described herein.

The stipulation process's design and execution have far-reaching implications for the legal collections industry including automation and standardization. The integration of tools like DocuSign and intelligent monitoring can provide for efficiency and reliability in collections workflows. The standardized processes can reduce variability, ensuring consistent outcomes for clients and consumers.

The stipulation process described herein can provide for data-driven decision making. For instance, the feedback loops capturing rejection causes enable data-driven refinements to the process, creating a self-improving system that adapts to evolving client and consumer needs.

The stipulation process described herein can provide for increased adoption of stipulations. By simplifying stipulation workflows, the systems and methods described herein make stipulations a more viable and attractive option for creditors, shifting the industry away from costly litigation.

While the foregoing written description provides examples of the technology, it will be understood that various changes, modifications, and combinations of the described features and components may be made. The disclosed techniques may be implemented in a variety of other contexts and are not limited to the specific domain of legal collections. For example, the terms “stipulation agreement,” “consumer,” and “attorney” are used for illustrative purposes and are not intended to be limiting; certain functional aspects, such as dynamic, rules-based document generation, sequential multi-party workflow management, and integrated feedback-based correction, can be applied to any transactional instrument or digital asset that may involve context-specific assembly and a structured, multi-participant approval process. The described system architecture, such as a cloud-based microservices model, is also exemplary; the disclosed techniques may be implemented at any scale, from a single-device, resource-constrained application to a large-scale, globally distributed enterprise system, and may utilize any suitable architecture, including centralized, decentralized, on-premise, or hybrid models. The various components and functions described herein can represent logical constructs, and their functions may be realized in dedicated hardware, such as an Application-Specific Integrated Circuit (ASIC) or a Field-Programmable Gate Array (FPGA), as software instructions executed by one or more general-purpose processors, or as any combination thereof. Furthermore, these logical functions may be combined into fewer components, further separated into more granular services, or distributed across different computing nodes in various arrangements. The disclosed techniques are therefore not to be limited in scope by the specific embodiments described herein, which are provided as illustrations of individual aspects of the technology.

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

Aspects of the disclosure have been described in terms of illustrative embodiments thereof. Any and all features in the following claims can be combined or rearranged in any way possible, including combinations of claims not explicitly enumerated in combination together, as the example claim dependencies listed herein should not be read as limiting the scope of possible combinations of features disclosed herein. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Clauses and other sequences of items joined by a particular conjunction such as “or,” for example, can refer to “and/or,” “at least one of”, “any combination of” example elements listed therein, etc. Terms such as “based on” should be understood as “based at least in part on.”

The term “can” should be understood as referring to a possibility of a feature in various implementations and not as prescribing an ability that is necessarily present in every implementation. For example, the phrase “X can perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

The term “may” should be understood as referring to a possibility of a feature in various implementations and not as prescribing an ability that is necessarily present in every implementation. For example, the phrase “X may perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

What is claimed is:

1. A computer-implemented method comprising:
accessing, by a first computing system, data indicative of a request for dynamic transaction document generation from a first client computing device;
based on accessing the data indicative of the request for dynamic transaction document generation, determining, by the first computing system, a first characteristic associated with the first client computing device;
based on the first characteristic associated with the client device, generating, by the first computing system, a transaction document, wherein the transaction document comprises at least a first portion selected based on the first characteristic;
generating, by the first computing system, first instructions that are executable by one or more processors of the first client computing device to cause the first client computing device to automatically update a graphical user interface to display the transaction document and a first interactive user interface element;
transmitting, by the first computing system, data comprising the first instructions to the first client computing device;
accessing, by the first computing system, data indicative of consumer user input via the first interactive user interface element indicative of a first user executing the transaction document;
based on accessing data indicative of the first user executing the transaction document, generating, by the first computing system, second instructions that are executable by one or more processors of one or more second client computing devices to cause the one or more second client computing devices to automatically update a graphical user interface to display the transaction document, a first signature associated with the first user executing the transaction document, and a second interactive user interface element;
transmitting, by the first computing system, the second instructions to the one or more second client computing devices, wherein the one or more second client computing devices are associated with a second user;
accessing, by the first computing system, data indicative of second user input via the second interactive user interface element indicative of the second user executing the transaction document; and
generating, by the first computing system, based on accessing the data indicative of the second user input, third instructions that are executable by one or more processors of one or more third client devices to automatically update a graphical user interface of the one or more third client devices to provide for display a notification indicating completion of the transaction document.

2. The computer-implemented method of claim 1, wherein generating the transaction document comprises accessing a compliance engine database comprising at least one of (i) legal requirements or (ii) client-specific disclosure preferences.

3. The computer-implemented method of claim 2, wherein the legal requirements comprise at least one of (i) federal legal requirements, (ii) state legal requirements, or (iii) local legal requirements.

4. The computer-implemented method of claim 3, wherein the first characteristic comprises a location of the first client computing device, and wherein the first portion comprises a portion associated with a state legal requirement.

5. The computer-implemented method of claim 1, wherein the one or more second client computing devices are associated with a legal entity comprising a plurality of second users including the second user.

6. The computer-implemented method of claim 1, wherein the transaction document comprises a stipulation agreement comprising at least a total payoff amount, a monthly payment amount, and a time to payoff.

7. The computer-implemented method of claim 1, wherein the first user comprises a consumer user and the second user comprises an attorney user.

8. The computer-implemented method of claim 1, comprising:
authenticating, by the first computing system, a first user session associated with the first client computing device; and
based on authenticating the first user session, generating, by the first computing system, the first instructions.

9. The computer-implemented method of claim 1, wherein the one or more third client devices are associated with a creditor entity.

10. One or more non-transitory computer readable media storing instructions that are executable by one or more processors to perform operations, the operations comprising:
accessing, by a first computing system, data indicative of a request for transaction document generation from a first client computing device;
based on accessing the data indicative of the request for transaction document generation, determining, by the first computing system, a first characteristic associated with the first client computing device;
based on the first characteristic associated with the first client computing device, generating a transaction document, wherein the transaction document comprises at least a first portion selected based on the first characteristic;
generating, by the first computing system, first instructions that are executable by one or more processors of the first client computing device to cause the first client computing device to automatically update a graphical user interface to display the transaction document and a first interactive user interface element;
transmitting data comprising the first instructions to the first client computing device;
accessing, by the first computing system, data indicative of first user input via the first interactive user interface element indicative of a first user rejecting the transaction document and a reason for the first user rejecting the transaction document;
based on accessing the data indicative of the first user rejecting the transaction document, updating, by the first computing system, a status data structure to update a status associated with the transaction document to be a rejected by first user status;
generating, by the first computing system, an updated transaction document based on the reason for the first user rejecting the transaction document by:
processing structured data comprising the reason for the first user rejecting the transaction document;
based on processing the structured data, automatically querying one or more databases to regenerate the transaction document;
generating, by the first computing system, second instructions that are executable by the one or more processors of the first client computing device to cause the first client computing device to automatically update the graphical user interface to display the updated transaction document and an updated interactive user interface element;
accessing, by the first computing system, data indicative of second user input via the updated interactive user interface element indicative of the first user executing the transaction document; and
based on accessing data indicative of the first user executing the transaction document, modifying, by the first computing system, the status data structure to update the status associated with the transaction document to be an accepted by the first user status.

11. The one or more non-transitory computer readable media of claim 10, the operations comprising:
based on accessing data indicative of the first user executing the transaction document, generating, by the first computing system, third instructions that are executable by one or more processors of one or more second client computing devices to cause the one or more second client computing devices to automatically update a graphical user interface to display the transaction document, a first signature associated with the first user executing the transaction document, and a second interactive user interface element;
transmitting, by the first computing system, the third instructions to the one or more second client computing devices, wherein the one or more second client computing devices are associated with a second user;
accessing, by the first computing system, data indicative of second user input via the second interactive user interface element indicative of the second user executing the transaction document; and
generating, by the first computing system, based on accessing the data indicative of the second user input, fourth instructions that are executable by one or more processors of one or more third client devices to automatically update the graphical user interface of the one or more third client devices to provide for display a notification indicating completion of the transaction document.

12. The one or more non-transitory computer readable media of claim 10, wherein generating the transaction document comprises accessing a compliance engine database comprising at least one of (i) legal requirements or (ii) client-specific disclosure preferences.

13. The one or more non-transitory computer readable media of claim 12, wherein the legal requirements comprise at least one of (i) federal legal requirements, (ii) state legal requirements, or (iii) local legal requirements.

14. The one or more non-transitory computer readable media of claim 13, wherein the first characteristic comprises a location of the first client computing device, and wherein the first portion comprises a portion associated with a state legal requirement.

15. The one or more non-transitory computer readable media of claim 10, wherein the first characteristic comprises at least one of: (i) a jurisdiction of the first user, (ii) an identity of the first user, or (iii) an account type.

16. A computing system comprising:
a compliance engine database comprising a plurality of compliance rules, wherein each respective rule is associated with at least one of: (i) a jurisdiction or (ii) a client identifier;
one or more processors;
one or more non-transitory computer-readable media storing instructions that are executable by one or more processors to perform operations, the operations comprising:
receiving a request for a transaction document, wherein the request is associated with the jurisdiction and the client identifier;
querying the compliance engine database to identify a subset of the plurality of compliance rules associated with the jurisdiction and the client identifier;
generating a transaction document by modifying a template document based on the identified subset of the plurality of compliance rules.

17. The computing system of claim 16, wherein generating the transaction document further comprises:
querying a database comprising data associated with the client identifier;
based on the data associated with the client identifier modifying one or more fields associated with the template document.

18. The computing system of claim 17, wherein the data associated with the client identifier comprises at least one of: (i) an account age, (ii) a debt principal, (iii) a debt type, (iv) a consumer credit score, (v) a consumer payment history, (vi) a historical stipulation success rate, (vii) estimated litigation costs.

19. The computing system of claim 16, comprising:
processing, by a machine-learning model, input comprising data associated with the client identifier to generate output comprising: (i) a stipulation recommendation and (ii) a confidence score.

20. The computing system of claim 19, wherein the output of the machine-learning model further comprises: (i) an estimated net recovery for stipulation and (ii) an estimated net recovery for litigation.
